(19) United States
(12) Patent Application Publication
(10) Pub. No.: US 2025/0040543 A1
(43) Pub. Date: Feb. 6, 2025

(54) Preservative Composition

(71) Applicant: ARXADA AG, Visp (CH)

(72) Inventors: Philip Lewis Roebbuck, West Yorkshire (GB); Louise Reay, West Yorkshire (GB); Jordan Petkov, West Yorkshire (GB); Thomas Pointon, West Yorkshire (GB); Ronan Green, West Yorkshire (GB)

(21) Appl. No.: 18/696,436

(22) PCT Filed: Nov. 15, 2022
(86) PCT No.: PCT/EP2022/081923

§ 371 Date: Mar. 28, 2024

(30) Foreign Application Priority Data
Nov. 15, 2021 (EP) 21 208 321.6
Oct. 19, 2022 (EP) 22 202 561.1

(51) Int. Cl. A01N 37/02; A01N 33/12; A01N 37/06; A01N 37/10; A01N 37/44; A01N 43/16; A01N 43/40; A01N 43/80; A01N 47/44; A01P 1/00; A01P 3/00

(52) U.S. Cl. CPC A01N 37/02; A01N 33/12; A01N 37/06; A01N 37/10; A01N 37/44; A01N 43/16; A01N 43/40; A01N 43/80; A01N 47/44; A01P 1/00; A01P 3/00

(57) ABSTRACT

The present invention relates to a preservative composition containing a preservative agent and a potentiator ingredient and an end-use formulation comprising the preservative composition.

### TECHNICAL FIELD

The present invention relates to a preservative composition containing a preservative agent and a potentiator ingredient and an end-use formulation comprising the preservative composition.

### TECHNOLOGICAL BACKGROUND

Microbial contamination of personal care products, cosmetics, home care products and other similar products is a matter of great importance to the personal care industry. Microbial contamination can become a major cause of product losses of end-use formulations and can cause significant economic loss. Further, contamination of cosmetics and home care products can result in their being converted into products that are hazardous for consumers. Certain, preservative agents and preservative compositions for protecting against microbial attack either from bacterial or fungal sources are known in the art. These preservative agents have a wide variety of applications in fields such as personal care products, cosmetics, home care products, and health and hygiene products.

Personal care products span a wider range of pH and consequently require preservation systems to maintain their shelf-lives. However, many of the preservative agents are organic acids or salts of organic acids which are not capable to ensure preservation above their pKa points, specifically at pH that approach a neutral pH or higher. This is why above their pKa short organic acids (and their salts) are dissociated such that they are no longer able to provide antimicrobial efficacy.

Although higher concentrations of preservative agents in personal care products could at least partially compensate for this loss of preservation efficacy at pH that approach a neutral pH or higher, there are continued regulatory pressures to reduce the amount of the preservative agent(s) in end-use formulations. Similarly, in the field of personal care products there are ongoing regulatory pressures to reduce the amount of the active ingredient in personal care products. Additionally, there are continued regulatory pressures to stop using certain conventional preservatives or to reduce the amount of certain conventional preservatives in end-use formulations. From an economic perspective, it is also desirable to reduce the amount of preservative agents to a minimum.

Accordingly, a need exists for preservative compositions that contain less active ingredient or preservative agents while maintaining acceptable levels of overall antimicrobial efficacy.

### SUMMARY OF THE INVENTION

It is an object of the present invention to provide a preservative composition which can be used in various compositions e.g. in home and personal care formulations, which ensures good preservation efficacy while requiring low amounts of preservative agents. Furthermore, the inventive preservative composition may provide effective, broad spectrum preservation activity over a broad pH range.

This object is solved by the preservative composition of the present invention.

In one aspect of the invention, a preservative composition is provided, which comprises (i) at least one preservative agent and (ii) at least one levuinic acid derivative selected from (a) a levulinic acid ester, or (b) a levuinic ketal, and combinations thereof. The at least one levuinic acid derivative is present in an amount sufficient to increase the efficacy of the preservative agent as compared to the preservative agent alone.

In another aspect of the invention, an end-use formulation is provided which comprises the preservative composition of the present invention.

A further aspect of the invention provides the use of the preservative composition according to the present invention for increasing the efficacy against microorganisms compared to an equal amount of the preservative agent without the at least one levuinic acid derivative.

A further aspect of the invention provides the use of at least one levuinic acid derivative selected from (a) a levuinic acid ester, or (b) a levuinic ketal, and combinations thereof for increasing the efficacy of at least one preservative agent against microorganisms compared to an equal amount of the preservative agent without the at least one levulinic acid derivative.

A further aspect of the invention provides a method for preventing an end-use formulation from spoilage by microorganisms, which method comprises adding the preservative composition according to the present invention to the end-use formulation.

### DETAILED DESCRIPTION

As already outlined above, the present invention pertains to a preservative composition comprising (i) at least one preservative agent and (ii) at least one levuinic acid derivative selected from (a) a levulinic acid ester, or (b) a levuinic ketal, and combinations thereof. In one embodiment, the at least one levuinic acid derivative is present in an amount sufficient to increase the efficacy of the preservative agent as compared to the preservative agent alone.

As used herein, the term “preservative” means a biocidal agent or biocidal composition which is intended to be blended with into an end-use formulation, such as personal care products, cosmetics, home care products, and health and hygiene products, to prevent microorganisms from destroying the end-use formulation or making the end-use formulation unusable for the particular purpose for which the end-use formulation was developed.

It has been surprisingly found that adding an amount of a levulinic acid derivative to a preservative composition comprising a preservative agent intended for an end-use formulation can provide an effectively preserved end-use formulation with a synergistic interaction between the preservative agent and the levulinic acid derivative. Thus, the inventors surprisingly found that the levulinic acid derivative acts as potentiator of the preservative agent. Typically, the end-use formulation has a pH of 4 or higher. The end-use formulation may also have an about neutral pH or higher, such as a pH of about 6 or higher. A pH of about 4 or higher includes a pH of 4, 4.5, 5, 5.5, 6, 6.5, 7, 7.5, 8, 8.5, 9, 9.5, and 10 or higher. In one embodiment, the at least one levuinic acid derivative is present in an amount sufficient to increase the efficacy of the preservative agent at a pH of from 4 to 9, preferably of from 6 to 8, as compared to the preservative agent alone.

As used herein, a “synergistic interaction” refers to the fact that the preservative, when combined with the levuinic acid derivative has a total antimicrobial/antifungal effect that is greater than the antimicrobial/antifungal properties of the preservative alone, or the levuinic acid derivative alone. In other words, the preservative agent of the present invention operates synergistically with the levulinic acid derivative(s) so as to have greater antimicrobial/antifungal activity in the presence of each against certain microorganisms than in comparison to the antimicrobial activity of the preservative alone or the antimicrobial activity of the levuinic acid derivative alone at the same concentrations. Due to the synergistic effect, the amount of the preservative present in the preservative composition can be reduced while still producing the desired efficacy. This effect is also known as “potentiation” of the preservative agent in the preservative composition. This potentiation of the preservative agent is also referred to herein as a “synergistic effect” between the preservative agent and the levulinic acid derivative(s) for boosting the efficacy of the preservative agent.

Further, the use of the preservative composition according to the present invention and the use of at least one levulinic acid derivative according to the present invention provide numerous technical advantages and benefits. For example, the preservative composition according to the present invention maintains broad-spectrum activity against all types of microorganisms at various pH levels. Furthermore, the preservative composition according to the present invention generally remains stable during changes in temperature and changes encountered during manufacturing, packaging, shipping, and storage of the end-formulation in which the preservative composition may be included. Further, the preservative composition according to the present invention is physically and chemically compatible with ingredients present in various end-use formulations. Lastly, the preservative composition of the present invention may contain lesser amounts of a preservative agent yet still provide antimicrobial efficacy consistent with industry standards.

The compositions of the present invention can include, consist essentially of, or consist of, the components of the present invention as well as other ingredients described herein. As used herein, “consisting essentially of” means that the composition or component may include additional ingredients, but only if the additional ingredients do not materially after the basic and novel characteristics of the claimed composition or methods.

As used herein, the term “about” modifying the quantity of a substance, ingredient, component, or parameter employed refers to variation in the numerical quantity that can occur, for example, through typical measuring and handling procedures, e.g., liquid handling procedures used for making concentrates or solutions. Furthermore, variation can occur from inadvertent error in measuring procedures, differences in the manufacture, source, or purity of the ingredients employed to carry out the invention. In one embodiment, the term “about” means within 10% of the reported numerical value. In a more specific embodiment, the term “about” means within 5% of the reported numerical value.

Suitable preservative agents usable in the present invention include an acid compound and salts thereof, an aldehyde, a phenolic compound, a sulfite, an iron chelator, an aromatic alcohol, a quaternary ammonium compound, a pyrone compound, a urea compound, a guanidine compound, a pyridine compound, an imidazole compound, an isothiazolinone compound, an amine compound, or any combination thereof.

In one embodiment, the preservative agent may be an acid compound and salts thereof, including both aromatic and non-aromatic acids. Exemplary acids include, for example, benzoic acid, propionic acid, salicylic acid, sorbic acid, formic acid, undec-10-enoic acid, lactic acid, glycolic acid, levulinic acid and citric acid. As used herein, the term “acid compound” is meant to include the respective salt(s) of this acid. Examples of salts include lithium, sodium, potassium, magnesium, and calcium salts, such as sodium benzoate, sodium lactate, sodium levulinate and potassium sorbate. In other words, all references to acids as preservative agents likewise include salts of such acids. Other salts may also be used. Acid compounds are typically used as preservatives in end-use formulations in amounts of up to about 3% by weight based on the weight of the end-use formulation, depending on the particular acid compound. Similar amounts may be used for the salts. Typically, the acid or salt thereof are used in an amount of from 1 wt.-% or less, such as in an amount of 0.5 wt.-% or less, based on the weight of the end-use formulation. Mixtures of acids may also be used as the preservative agent.

Preferably, the acid compound and salts thereof is selected from the group consisting of benzoic acid or a salt thereof, lactic acid or a salt thereof, sorbic acid or a salt thereof, levulinic acid or a salt thereof, and combinations thereof. More preferably, the acid compound and salts thereof is selected from the group consisting of benzoic acid, sodium benzoate, lactic acid, sodium lactate, sorbic acid, potassium sorbate, levulinic acid, sodium levulinate, and combinations thereof. Even more preferably, the acid compound and salts thereof is selected from the group consisting of benzoic acid, sodium benzoate, lactic acid, sodium lactate, sorbic acid, potassium sorbate, and combinations thereof.

In another embodiment, the preservative agent may be an aldehyde. Exemplary aldehydes include, for example, formaldehyde and paraformaldehydes. Exemplary aldehyde forming agents include imidazolidine compounds like hydantoins, such as dimethylol dimethyl hydantoin, (DMDMH) and other similar aldehyde forming hydantoins. Depending on the use, the aldehydes may be present in the composition to be preserved in amounts up to 0.3% by weight. Typically, the amount of the aldehydes is up to 0.2% based on the weight of the composition to be preserved. Mixtures of aldehydes may also be used as the preservative agent.

In a further embodiment, the preservative agent may be a phenolic compound. Exemplary phenolic compounds include, for example, paraben compounds, biphenyl-2-ol (o-phenylphenol) or salts thereof, 4-chloro-m-cresol, 5-Chloro-2-(2,4-dichlorophenoxy)phenol (trickosan), 4-Chloro-3,5-dimethylphenol, 4-isopropyl-m-cresol, 2-benzyl-4-chlorophenol, and bromchlorophen. Exemplary paraben compounds include, for example butyl paraben, propyl paraben, ethyl paraben, methyl paraben and salts thereof, including, for example, potassium, sodium and/or calcium salts. Phenolic compounds are typically used as preservatives in end-use formulation in amounts up to about 1% by weight, based on the weight of the total end-use formulation. This upper limit depends on the particular phenolic compound. More typically up to about 0.5% by weight of the phenolic compound is used in cosmetic formulations.

In yet another embodiment, the preservative agent may be a compound which is known as an iron chelator, wherein the iron chelator is selected from pyrithione compounds, hydroxyl pyridine compounds, and salts thereof. Pyrithione is known by several names, including 2 mercaptopyridine-N-oxide; 2-pyridinethiol-1-oxide (CAS Registry No. 1121-31-9); 1-hydroxypyridine-2-thione and 1-hydroxy-2(1H)-pyridinethione (CAS Registry No. 1121-30-8). Pyrithione salts are commercially available from Arxada AG, such as Sodium OMADINE® or Zinc OMADINE®. Preferably, the hydroxyl pyridine compound is 2-pyridinol-1-oxide (HPNO; also referred to as 2-hydroxypyridine-N-oxide).

The pyrithione present as the preservative agent can be present in a water insoluble form or in a water-soluble form. The pyrithione may comprise sodium pyrithione, zinc pyrithione, barium pyrithione, strontium pyrithione, copper pyrithione, cadmium pyrithione, and/or zirconium pyrithione. Other pyrithiones that may be present in the composition include sodium pyrithione, bismuth pyrithione, potassium pyrithione, lithium pyrithione, ammonium pyrithione, calcium pyrithione, magnesium pyrithione, silver pyrithione, gold pyrithione, manganese pyrithione, and/or an organic amine pyrithione. A single pyrithione may be present as the preservative agent or a combination of any of the above may be included as the preservative agent. Preferably, the pyrithione is sodium pyrithione.

The pyrithione particles can have a particle size such that 100% of the particles have a particle size of less than about 10 microns and at least 70% of the particles have a particle size less than 5 microns, such as at least about 50% of the particles can have a particle size of 1 micron or less. Particle size can be measured using a laser scattering particle size analyzer, such as a HORIBA LA 910 particle size analyzer.

The pyrithione particles can be produced by reacting pyrithione or a water-soluble salt of pyrithione, and a water-soluble polyvalent metal salt in a pressurized, turbulent flow reactor that generates pulverizing forces. The pulverizing forces produced by the pressurized, turbulent flow reactor efficiently generate pyrithione salt particles of micron size. The micron-sized pyrithione salt particles made by the method have a narrow and uniform size distribution and have excellent surface deposition properties due to the large surface area provided by the population of micron particles. Iron chelator compounds are typically used as preservatives in end-use formulations in amounts up to about 1% by weight, depending on the particular compound. Of particular interest are zinc pyrithione and piroctone olamine. These iron chelators may also have other advantages, such as providing other benefits, including antidandruff properties.

In another embodiment, the preservative agent may include inorganic sulfite compounds and hydrogen sulfites compounds. Sulfite compound are generally present in amounts up about 0.5% by weight, based on the total weight of the end-use formulation.

In some embodiments, the preservative agent includes alcohol compounds. The alcohol may be a lower alcohol or an aromatic alcohol. Lower alcohols are typically selected among mono-functional low-molecular alcohols, preferably alkanols with one to four carbon atoms such as methanol, ethanol, isopropanol or butanol, or combinations thereof. Substituted alcohols, such a chlorobutanol may also be used. Particularly suitable lower alcohols include ethanol and isopropyl alcohol. Aromatic alcohols may also be used. Suitable aromatic alcohols include phenoxyethanol, 2,4-Dichlorophenyl)methanol, benzyl alcohol, 1-Phenoxypropaneol, chlorphenesin, and benzyl hemiformal. One particularly preferred alcohol is phenoxyethanol. Another particularly preferred alcohol is benzyl alcohol. The alcohol compounds may be used as preservative agents in end-use formulations in amounts up to about 1.5% by weight based on the total weight of the end-use formulation, depending on the particular alcohol compound. In most cases, the amount of the alcohol compounds is typically used in amounts up about 1% by weight, more typically up to about 0.5% by weight, based on the weight of the end-use formulation.

In another embodiment, one or more quaternary ammonium compounds may be used as preservative agent. Quaternary ammonium compounds, also known as “quats”, typically comprise at least one quaternary ammonium cation with an appropriate anion. Quats will generally have the general formula (1).

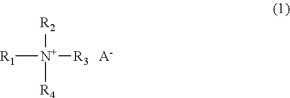

The groups R₁, R₂, R₃ and R₄ can vary within wide limits and possess anti-microbial properties. Typically, at least one, such as at least two, of R₁, R₂, R₃ and R₄ is a lower alkyl, meaning having 1 to 4 carbon atoms, such as a methyl, ethyl, propyl or butyl group. In one aspect, at least one, such as least two of R₁, R₂, R₃ and R₄ is a longer chain alkyl group of 6 to 24 carbon atoms. R₄ can also be a substituted or unsubstituted benzyl group such as an ethylbenzyl group, or an alkoxy group. A- is a monovalent anion or one equivalent of a polyvalent anion of an inorganic or organic acid. Suitable anions for A- are in principle all inorganic or organic anions, in particular halides, for example chloride or bromide, carbonates, bicarbonates, carboxylates, sulfonates, phosphates, propionates, saccharinates, or a mixture thereof. Carboxylates may be derived from lower carboxylic acids or from fatty acids.

Alkyl, hereinafter, is taken to mean in each case unbranched or branched alkyl groups of the specified number of carbons, but preferably unbranched alkyl groups, and particularly preferably those having an even number of carbon atoms. In particular, this is also taken to mean the homologue mixtures derived from natural raw materials, for example “cocoalkyl”.

In one embodiment, the quaternary ammonium compound may have the following R groups: R₁, R₂ and R₃ are alkyl groups and R₄ is a benzyl group, a C₁₋₁₈ alkyl group such as a C₆₋₁₈ alkyl group, or an alkoxy group such as a group having the structure —[(CH₂)₂—O]ₙR₅ where n=1-20 and R₅ is hydrogen or an unsubstituted or substituted phenyl, and A- is as described above, such as a monovalent anion or one equivalent of a polyvalent anion of an inorganic or organic acid. For example, R₁ is an alkyl group having 1 to 4 carbon atoms and R₂ and R₃ are independently alkyl groups having 6 to 24 carbon atoms, or R₁ and R₂ are independently alkyl groups having 1 to 4 carbon atoms and R₃ is an alkyl group having 6 to 24 carbon atoms.

Suitable quaternary ammonium compounds include, for example alkyl (C₁₂₋₂₂) trimethyl ammonium bromide, alkyl (C₁₂₋₂₂) trimethyl ammonium chloride compounds including, for example cetrimonium bromide, cetrimonium chloride, laurtrimonium bromide, laurtrimonium chloride, steartrimonium bromide, and steartrimonium chloride or mixture thereof, benzethonium compound, including, for example benzalkonium chloride, benzalkonium bromide and benzalkonium saccharinate.

Suitable quaternary ammonium compounds include alkyldimethylbenzylammonium chloride (ADBAC), preferably C₁₂-C₁₆ alkyldimethylbenzylammonium chloride. Alkyldimethylbenzylammonium chloride (ADBAC) is commercially available as Barquat® BAC-50 from Arxada AG.

In one embodiment, the quaternary ammonium compound may comprise a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds include dimethyl dioctyl ammonium compounds such as dimethyl dioctyl ammonium chloride, dimethyl didecyl ammonium compounds such as dimethyl didecyl ammonium chloride and the Ike. Mixtures of dimethyl dialkyl ammonium compounds may also be used, and other anions, such as those described above, may also be used. Commercially available dimethyl dialkyl ammonium compounds include, for example, compositions marketed and sold under the BARDAC®, BARDAP®, BARQUAT®, or CARBOQUAT® trade names by Arxada AG.

Such commercially available examples of dimethyl dialkyl ammonium compounds include dioctyldimethylammonium chloride (available as Bardac® LF and LF-80 from Arxada AG), octyldecyldimethylammonium chloride (available as a mixture of octyldecyldimethylammonium chloride, dioctyldimethylammonium chloride, and didecyldimethyl ammonium chloride as Bardac® 2050 and 2080 from Arxada AG), didecyldimethylammonium chloride (available as Bardac® 2250 and 2280 from Arxada AG), decylisononyldimethylammonium chloride (available as Bardac® 21 from Arxada AG), diisodecyldimethylammonium chloride (available as BTC 99 from Stepan Co. of Northfield, Ill.), and any combination of any of the foregoing.

Preferably, the quaternary ammonium compound is selected from the group consisting of didecyl dimethyl ammonium chloride, benzalkonium chloride, alkyldimethylbenzylammonium chloride (ADBAC), and combinations thereof. More preferably, the quaternary ammonium compound is alkyldimethylbenzylammonium chloride (Barquat® BAC-50).

The quaternary ammonium compounds may be included in end-use formulations in amounts up to about 0.2% by weight based on the total weight of the end-use formulation, depending on the particular quaternary ammonium compound. In certain embodiments, the end-use formulation may contain from about 0.1% by weight to about 0.05% by weight, based on the weight of the end-use formulation.

Exemplary pyrone compounds useable in the present invention as a preservative agent include, for example, dehydroacetic acid and salts thereof, such as sodium dehydroacetate. Pyrone compounds may be used in amount up to about 1.0% by weight, based on the total weight of the end-use formulation. In some embodiments, one or more pyrone compounds may be used in an amount of up to about 0.6% by weight. Preferably, the pyrone compound is selected from dehydroacetic acid or a salt thereof. More preferably, the pyrone compound is selected from dehydroacetic acid, sodium dehydroacetate, and combinations thereof. Even more preferably, the pyrone compound is dehydroacetic acid.

One more urea compounds may be used as the preservative agent in certain embodiments, Exemplary urea compounds include, for example, 3-(4-Chlorophenyl)-1-(3,4-dichlorophenyl)urea (triclocarban); 1,1′-methylenebis{3-[4-(hydroxymethyl)-2,5-dioxoimidazoidin-4-yl]urea}; and N-(hydroxymethyl)-N-(dihydroxymethyl-1,3-dioxo 2,5-imidazolinidyl-4)-N′-(hydroxymethyl) urea. These compounds are typically used in amounts up to about 0.5% by weight of the end-use formulation.

Exemplary imidazole compounds useable in the present invention as the preservative agent include, for example, 1-(4-chlorophenoxy)-1-(imidazole-1-yl)-3,3-dimethylbutan-2-one); 1,3-Bis(hydroxymethyl)-5,5-dimethylimidazoidine-2,4-dione). In some embodiments, one or more urea compounds may be included in an amount of up to about 0.5% by weight of the end-use formulation.

In some embodiments, the preservative agent may include one or more isothiazolinones. Exemplary isothiazolinones include, for example 5-chloro-2-methyl-isothiazol-3-one (chloromethyisothiazolinone), 2-methyl-isothiazol-3-one (methylsothiazolinone), benzisothiazolinone (BIT), 2-butyl-1,2-benzisothiazolin-3-one (BBIT), and mixtures thereof. In certain embodiments, one or more isothizaolinones may be used in an amount of up to about 0.01% by weight of the end-use formulation. Preferably, the isothiazolinone is selected from benzisothiazolinone (BIT), 2-butyl-1,2-benzisothiazolin-3-one (BBIT), and combinations thereof. More preferably, the isothiazolinone is benzisothiazolinone (BIT).

In still another aspect, the preservative agent can be an amine compound, such as a triamine compound. Suitable triamine compounds include, but are not limited to, those having the formula (2)

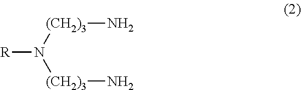

where R is a substituted or unsubstituted C₈ to C₁₈ alkyl, C₈ to C₁₈ alkenyl, C₈ to C₁₈ alkynyl, or C₈ to C₁₈ cycloalkyl or aryl, and R is optionally interrupted with one or more heteroatoms.

The term “substituted” as used herein includes compounds substituted with one or more of halogen (such as F, Cl, I, or Br); heteroatomic groups; C₈ to C₁₈ alkyl; C₈ to C₁₈ alkenyl; C₈ to C₁₈ alkynyl; C₈ to C₁₈ cycloalkyl; aryl; or carbonyl containing C₈ to C₁₈ alkyl, C₈ to C₁₈ alkenyl, or C₈ to C₁₈ alkynyl groups (such as ketones, esters, ethers, carbonates, or carboxylates).

Suitable heteroatoms include, but are not limited to, 0, N, P, and S.

Suitable heteroatomic groups include, but are not limited to, —NH₂, —NO₂, —SO₂, —SO₃, —PO₃, ═O, and —OH.

The substituent R is preferably unsubstituted C₈ to C₁₈ alkyl, C₈ to C₁₈ alkenyl, C₈ to C₁₈ alkynyl, C₈ to C₁₈ cycloalkyl, or aryl. Preferred triamines include, but are not limited to, N,N-bis(3-aminopropyl)-dodecylamine, available as Lbac® 12 from Arxada AG, bis(3-aminopropyl)octylarrine, and N,N-bis(3-aminopropyl)-octylamine.

Another suitable amine compound is trisodium dicarboxymethyl alaninate.

Preferably, the amine compound is selected from N,N-bis(3-aminopropyl)-dodecylamine and trisodium dicarboxymethyl alaninate.

The amine preservative agent can generally be included in an amount up to about 2% by weight of the end use formulation, and particularly from about 50 ppm to about 200,000 ppm, such as from about 50 ppm to about 500 ppm.

In one embodiment, the preservative agent can be a carbamate compound. Suitable carbamate compounds which can be used as preservative agent include iodopropynnyl alkylcarbamates such as 3-Iodo-2-propynyl butylcarbamate (IPBC). Preferably, the carbamate compound is 3-Iodo-2-propynyl butylcarbamate (IPBC).

In one embodiment, the preservative agent can be a guanidine compound. Suitable guanidine compounds which can be used as preservative agent include polymeric guanidine compounds such as oligomeric or polymeric biguanide compounds. Suitable guanidine compounds include polyhexamethylene guanidine (PHMG), poly(hexamethylene) biguanide (PHMB), and polyaminopropyl biguanide (PAPB). Preferably, the guanidine compound is poly(hexamethylene) biguanide (PHMB).

Other components that may be used as a preservative agent include dibromohexamidine and salts thereof; thiomersal; phyenylmercuric salts; hexetidine; 2-bromo-2-nitropropane-1,3-diol; 5-bromo-5-nitro-1,3-dioxane; polyhexamethylenebiguanide or salts thereof; hexamethylenetetrarrine; methenamine 3-chloroallylochloride; 2-chloroacetamide; chlorohexidine and its diglucononate, or diacetate esters and dihydrochloride salt thereof; 4,4-dimethyl, 1,3-oxazolidine; glutaraldehyde; 5-ethyl-3,7-dioxa-1-azabicyclo octane; sodium hydroxymethylglycinate, 3-Iodo-2-propynyl butylcarbamate (IPBC) and ethyl lauroyl alginate. In certain embodiments, these components may be included in an amount of up to about 0.5% by weight of the end-use formulation.

In addition, the preservative agent may be a single preservative agent, a mixture of two or more preservative agents from a single type of preservative agent or may be a mixture of two or more different types of preservative agents.

In one embodiment, the preservative agent is selected from the group consisting of phenoxyethanol, N,N-bis(3-aminopropyl) dodecylamine, didecyl dimethyl ammonium chloride, sodium benzoate, benzoic acid, lactic acid, sodium lactate, benzyl alcohol, benzisothiazolinone, sorbic acid, potassium sorbate, 3-Iodo-2-propynyl butylcarbamate (IPBC), dehydroacetic acid, sodium dehydroacetate, levuinic acid, sodium levulinate, sodium pyrithione, trisodium dicarboxymethyl alaninate, 2-butyl-1,2-benzisothiazolin-3-one, benzalkonium chloride, alkyldimethylbenzylammonium chloride (ADBAC), 2-hydroxypyridine-N-oxide, poly(hexamethylene) biguanide, and combinations thereof.

In one embodiment, the preservative agent is selected from the group consisting of sodium benzoate, benzoic acid, potassium sorbate, 3-Iodo-2-propynyl butylcarbamate (IPBC), phenoxyethanol, bis(3-aminopropyl) dodecylamine, didecyl dimethyl ammonium chloride, lactic acid, sodium lactate benzyl alcohol, benzisothiazolinone, sorbic acid, dehydroacetic acid, sodium dehydroacetic acid, levuinic acid, sodium pyrithione and combinations thereof.

Preferably, the preservative agent is selected from the group consisting of sodium benzoate, benzoic acid, potassium sorbate, sorbic acid, 3-Iodo-2-propynyl butylcarbamate (IPBC), alkyldimethylbenzylammonium chloride (ADBAC), sodium pyrithione, lactic acid, sodium lactate, trisodium dicarboxymethyl alaninate, dehydroacetic acid, sodium dehydroacetate, benzisothiazolinone, 2-hydroxypyridine-N-oxide, poly(hexamethylene) biguanide, and combinations thereof.

More preferably, the preservative agent is selected from the group consisting of sodium benzoate, potassium sorbate, 3-Iodo-2-propynyl butylcarbamate (IPBC), alkyldimethylbenzylammonium chloride (ADBAC), sodium pyrithione, lactic acid, trisodium dicarboxymethyl alaninate, dehydroacetic acid, benzisothiazolinone, 2-hydroxypyridine-N-oxide, poly(hexamethylene) biguanide, and combinations thereof.

Preferably, the preservative agent is selected from the group consisting of sodium benzoate, potassium sorbate, 3-Iodo-2-propynyl butylcarbamate (IPBC), and combinations thereof.

The preservative composition of the present invention includes at least one levulinic acid derivative selected from (a) a levulinic acid ester, or (b) a levuinic ketal, and combinations thereof. Levulinic acid esters and levuinic ketals usable in the present invention may be derived from (hemi)cellulosic feedstock and the Ike.

Suitable levuinic acid esters include, but are not limited to, those having the formula (3):

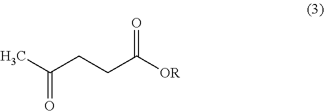

wherein R is C₁ to C₈ alkyl or C₃ to C₈ cycloalkyl.

As used herein C₁ to C₈ alkyl refers to a straight-chained or branched saturated hydrocarbon group having 1 to 8 carbon atoms including methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, 1,1-dimethylpropyl, 1,2-dimethylpropyl, hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethyl propyl, 1,2,2-trimethylpropyl, 1-ethyl-1-methylpropyl, 1-ethyl-2-methylpropyl, heptyl, and octyl. As such, C₁ to C₈ alkyl includes C₁, C₂, C₃, C₄, C₅, C₆, C₇ and C₈ alkyl.

As used herein C₃ to C₈ cycloalkyl refers to monocyclic saturated hydrocarbon radicals having 3 to 8 carbon ring members including cyclopropyl, cyclobutyl, cyclopentyl, cyclohexyl, cycloheptyl, and cyclooctyl. As such, C₃ to C₈ cycloalkyl C₃, C₄, C₅, C₆, C₇ and C₈ cycloalkyl.

Accordingly, in one embodiment, the levulinic acid ester is a C₁₋₈ alkyl levulinic acid ester, a C₃₋₈ cycloalkyl levulinic acid ester, or a combination thereof.

In one embodiment, the levuinic acid ester is selected from the group consisting of methyl levulinate, ethyl levulinate, propyl levulinate, butyl levulinate, pentyl levulinate and combinations thereof. Preferably, the levuinic acid ester is ethyl levulinate, butyl levulinate, or a combination thereof. In one preferred embodiment, the levuinic acid ester is ethyl levulinate. In one preferred embodiment, the levulinic acid ester is butyl levuinate.

The at least one levuinic acid derivative may, alternatively to or in addition to the levuinic acid ester, be a levuinic ketal.

In one embodiment, the levuinic ketal is selected from the group consisting of ethyl-3-(2,4-dimethyl-1,3-dioxolan-2-yl)propanoate, ethyl-3-[4-(hydroxymethyl)-2-methyl-1,3-dioxolan-2-yl]propanoate, and combination thereof.

In one embodiment, the preservative agent is sodium benzoate and the levulinic acid derivative is butyl levuinate. In one embodiment, the preservative agent is potassium sorbate and the levuinic acid derivative is butyl levuinate. In one embodiment, the preservative agent is 3-Iodo-2-propynyl butylcarbamate (IPBC) and the levuinic acid derivative is butyl levuinate.

In one embodiment, the preservative agent is phenoxyethanol and the levulinic acid derivative is ethyl levuinate. In one embodiment, the preservative agent is N,N-bis(3-aminopropyl) dodecylamine and the levuinic acid derivative is ethyl levuinate. In one embodiment, the preservative agent is didecyl dimethyl ammonium chloride and the levuinic acid derivative is ethyl levulinate. In one embodiment, the preservative agent is sodium benzoate and the levulinic acid derivative is ethyl levuinate. In one embodiment, the preservative agent is benzoic acid and the levulinic acid derivative is ethyl levulinate. In one embodiment, the preservative agent is lactic acid and the levuinic acid derivative is ethyl levuinate. In one embodiment, the preservative agent is sodium lactate and the levuinic acid derivative is ethyl levulinate. In one embodiment, the preservative agent is benzyl alcohol and the levuinic acid derivative is ethyl levuinate. In one embodiment, the preservative agent is benzisothiazoinone and the levuinic acid derivative is ethyl levuinate. In one embodiment, the preservative agent is sorbic acid and the levuinic acid derivative is ethyl levuinate. In one embodiment, the preservative agent is potassium sorbate and the levuinic acid derivative is ethyl levuinate. In one embodiment, the preservative agent is 3-Iodo-2-propynyl butylcarbamate (IPBC) and the levuinic acid derivative is ethyl levuinate. In one embodiment, the preservative agent is dehydroacetic acid and the levuinic acid derivative is ethyl levuinate. In one embodiment, the preservative agent is sodium dehydroacetate and the levuinic acid derivative is ethyl levuinate. In one embodiment, the preservative agent is levuinic acid and the levuinic acid derivative is ethyl levuinate. In one embodiment, the preservative agent is sodium levuinate and the levulinic acid derivative is ethyl levuinate. In one embodiment, the preservative agent is sodium pyrithione and the levulinic acid derivative is ethyl levulinate. In one embodiment, the preservative agent is trisodium dicarboxymethyl alaninate and the levuinic acid derivative is ethyl levulinate. In one embodiment, the preservative agent is 2-butyl-1,2-benzisothiazolin-3-one and the levulinic acid derivative is ethyl levuinate. In one embodiment, the preservative agent is benzalkonium chloride and the levuinic acid derivative is ethyl levuinate. In one embodiment, the preservative agent is alkyldimethylbenzylammonium chloride (ADBAC) and the levuinic acid derivative is ethyl levuinate. In one embodiment, the preservative agent is 2-hydroxypyridine-N-oxide and the levuinic acid derivative is ethyl levuinate. In one embodiment, the preservative agent is poly(hexamethylene) biguanide and the levulinic acid derivative is ethyl levulinate.

In one embodiment, the preservative agent is phenoxyethanol and the levulinic acid derivative is butyl levuinate. In one embodiment, the preservative agent is N,N-bis(3-aminopropyl) dodecylamine and the levulinic acid derivative is butyl levuinate. In one embodiment, the preservative agent is didecyl dimethyl ammonium chloride and the levuinic acid derivative is butyl levulinate. In one embodiment, the preservative agent is sodium benzoate and the levulinic acid derivative is butyl levuinate. In one embodiment, the preservative agent is benzoic acid and the levulinic acid derivative is butyl levulinate. In one embodiment, the preservative agent is lactic acid and the levuinic acid derivative is butyl levulinate. In one embodiment, the preservative agent is sodium lactate and the levuinic acid derivative is butyl levulinate. In one embodiment, the preservative agent is benzyl alcohol and the levuinic acid derivative is butyl levuinate. In one embodiment, the preservative agent is benzisothiazolinone and the levuinic acid derivative is butyl levulinate. In one embodiment, the preservative agent is sorbic acid and the levulinic acid derivative is butyl levuinate. In one embodiment, the preservative agent is potassium sorbate and the levuinic acid derivative is butyl levuinate. In one embodiment, the preservative agent is 3-Iodo-2-propynyl butylcarbamate (IPBC) and the levuinic acid derivative is butyl levuinate. In one embodiment, the preservative agent is dehydroacetic acid and the levuinic acid derivative is butyl levuinate. In one embodiment, the preservative agent is sodium dehydroacetate and the levuinic acid derivative is butyl levuinate. In one embodiment, the preservative agent is levuinic acid and the levulinic acid derivative is butyl levuinate. In one embodiment, the preservative agent is sodium levuinate and the levuinic acid derivative is butyl levuinate. In one embodiment, the preservative agent is sodium pyrithione and the levulinic acid derivative is butyl levulinate. In one embodiment, the preservative agent is trisodium dicarboxymethyl alaninate and the levuinic acid derivative is butyl levulinate. In one embodiment, the preservative agent is 2-butyl-1,2-benzisothiazolin-3-one and the levulinic acid derivative is butyl levuinate. In one embodiment, the preservative agent is benzalkonium chloride and the levuinic acid derivative is butyl levuinate. In one embodiment, the preservative agent is alkyldimethylbenzylammonium chloride (ADBAC) and the levuinic acid derivative is butyl levuinate. In one embodiment, the preservative agent is 2-hydroxypyridine-N-oxide and the levuinic acid derivative is butyl levulinate. In one embodiment, the preservative agent is poly(hexamethylene) biguanide and the levulinic acid derivative is butyl levulinate.

The weight ratio of the at least one levuinic acid derivative to the preservative agent can vary depending on a variety of factors. For example, the weight ratio of the at least one levulinic acid derivative to the preservative agent can depend on the composition of the final product, the microorganisms that are being controlled, the particular at least one levuinic acid derivative and preservative agent used, the final properties of the product, and the Ike.

The weight ratio of the at least one levuinic acid derivative to the preservative agent may in general range from about 10,000:1 to 1:100, such as from 8000:1 to 1:50. For example, the weight ratio of the at least one levuinic acid derivative to the preservative agent may in general range from about 10:1 to 1:100, such as from 9:1 to 1:90, such as from 8:1 to 1:80, such as from 7:1 to 1:70, such as from 6:1 to 1:60, such as from 5:1 to 1:50.

In many applications, only a small amount of the at least one levuinic acid derivative is needed in order to enhance the efficacy of the preservative agent. For example, in one aspect, the preservative agent is present in greater amounts than the at least one levulinic acid derivative.

In one embodiment, the preservative agent is sodium benzoate and the at least one levulinic acid derivative and the sodium benzoate are comprised in the preservative composition at a weight ratio of from 10:1 to 1:100, preferably of from 5:1 to 1:50. In one embodiment, the preservative agent is sodium benzoate and the at least one levuinic acid derivative and the sodium benzoate are comprised in the preservative composition at a weight ratio of from 100:1 to 1:100, preferably of from 50:1 to 1:50.

In one embodiment, the preservative agent is benzoic acid or a salt thereof and the at least one levulinic acid derivative and the benzoic acid or a salt thereof are comprised in the preservative composition at a weight ratio of from 100:1 to 1:100, preferably of from 50:1 to 1:50.

In one embodiment, the preservative agent is potassium sorbate and the at least one levulinic acid derivative and the potassium sorbate are comprised in the preservative composition at a weight ratio of from 10:1 to 1:100, preferably of from 1:1 to 1:50. In one embodiment, the preservative agent is potassium sorbate and the at least one levuinic acid derivative and the potassium sorbate are comprised in the preservative composition at a weight ratio of from 500:1 to 1:10.

In one embodiment, the preservative agent is 3-Iodo-2-propynyl butylcarbamate (IPBC) and the at least one levuinic acid derivative and the 3-Iodo-2-propynyl butylcarbamate (IPBC) are comprised in the preservative composition at a weight ratio of from 25:1 to 1:2, preferably of from 25:1 to 1:5.

In one embodiment, the preservative agent is alkyldimethylbenzylammonium chloride (ADBAC) and the at least one levuinic acid derivative and the alkyldimethylbenzylammonium chloride (ADBAC) are comprised in the preservative composition at a weight ratio of from 8000:1 to 500:1, preferably of from 7000:1 to 700:1.

In one embodiment, the preservative agent is sodium pyrithione and the at least one levulinic acid derivative and the sodium pyrithione are comprised in the preservative composition at a weight ratio of from 8000:1 to 5:1, preferably of from 7000:1 to 5:1.

In one embodiment, the preservative agent is levuinic acid and the at least one levulinic acid derivative and the levuinic acid are comprised in the preservative composition at a weight ratio of from 50:1 to 1:50, preferably of from 25:1 to 1:25.

In one embodiment, the preservative agent is phenoxyethanol and the at least one levuinic acid derivative and the phenoxyethanol are comprised in the preservative composition at a weight ratio of from 50:1 to 1:100, preferably of from 10:1 to 1:25.

In one embodiment, the preservative agent is lactic acid or a salt thereof and the at least one levulinic acid derivative and the lactic acid or a salt thereof are comprised in the preservative composition at a weight ratio of from 60:1 to 1:5, preferably of from 40:1 to 1:4.

In one embodiment, the preservative agent is sodium lactate and the at least one levulinic acid derivative and the sodium lactate are comprised in the preservative composition at a weight ratio of from 60:1 to 1:5, preferably of from 40:1 to 1:4.

The preservative composition according to any one of claims 1 to 9, wherein the preservative agent is trisodium dicarboxymethyl alaninate and wherein the at least one levuinic acid derivative and the trisodium dicarboxymethyl alaninate are comprised in the preservative composition at a weight ratio of from 5:1 to 1:5, preferably from 3:1 to 1:3.

In one embodiment, the preservative agent is benzyl alcohol and the at least one levuinic acid derivative and the benzyl alcohol are comprised in the preservative composition at a weight ratio of from 50:1 to 1:100, preferably of from 10:1 to 1:10.

In one embodiment, the preservative agent is sorbic acid or a salt thereof and the at least one levulinic acid derivative and the sorbic acid or a salt thereof are comprised in the preservative composition at a weight ratio of from 25:1 to 1:5, preferably of from 10:1 to 1:2. In one embodiment, the preservative agent is sorbic acid or a salt thereof and the at least one levulinic acid derivative and the sorbic acid or a salt thereof are comprised in the preservative composition at a weight ratio of from 500:1 to 1:10.

In one embodiment, the preservative agent is dehydroacetic acid or a salt thereof and the at least one levulinic acid derivative and the dehydroacetic acid or a salt thereof are comprised in the preservative composition at a weight ratio of from 25:1 to 1:5, preferably of from 10:1 to 1:2. In one embodiment, the preservative agent is dehydroacetic acid or a salt thereof and the at least one levulinic acid derivative and the dehydroacetic acid or a salt thereof are comprised in the preservative composition at a weight ratio of from 300:1 to 1:10, preferably of from 250:1 to 1:8. In one embodiment, the preservative agent is sodium dehydroacetate and the at least one levulinic acid derivative and the sodium dehydroacetate are comprised in the preservative composition at a weight ratio of from 300:1 to 1:10, preferably of from 250:1 to 1:8.

In one embodiment, the preservative agent is benzisothiazolinone and the at least one levulinic acid derivative and the benzisothiazolinone are comprised in the preservative composition at a weight ratio of from 200:1 to 1:10, preferably of from 150:1 to 1:5.

In one embodiment, the preservative agent is 2-hydroxypyridine-N-oxide and the at least one levulinic acid derivative and the 2-hydroxypyridine-N-oxide are comprised in the preservative composition at a weight ratio of from 75:1 to 1:1, preferably of from 60:1 to 1:1.

In one embodiment, the preservative agent is poly(hexamethylene) biguanide and the at least one levulinic acid derivative and the poly(hexamethylene) biguanide are comprised in the preservative composition at a weight ratio of from 800:1 to 5:1, preferably of from 700:1 to 7:1.

Various different microorganisms may be controlled in accordance with the present invention. For instance, the preservative composition of the present invention can control gram positive bacteria, gram negative bacteria, and the Ike. In addition to bacteria, the preservative composition of the present invention can also kill and control the growth of various other microorganisms, such as fungi, viruses, spores, yeast, mycobacteria, and the like. Non-limiting examples of particular microorganisms that may be controlled in accordance with the present invention include Staphylococcus aureus, Streptococcus pneumoniae, Pseudomonas aeruginosa, Serratia marcescens, Salmonella enteritidis, Neisseria gononhoeae, Escherichia coli, Enterococcus hirae, Acinetobacter baumannii, Listeria monocytogenes, Enterobacter gergoviae, Klebsiella pneumoniae, Burholderia cepacia, Pseudomonas putida, Kocuria rhizophila, Candda albicans, Saccharomyces cerevisiae, Aspergillus brasiliensis, Penicillium funiculosum, Eupenicillium levitum, Bacillus cereus, Bacillus subtilis, Clostidium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof. Preferably, the microorganism is selected from Aspergillus brasiliensis, Pseudomonas aeruginosa, Staphylococcus aureus, Escherichia coli, Candida albicans, and mixtures thereof.

The present invention further pertains to an end-use formulation comprising the preservative composition according to the present invention. The end-use formulation may have a pH of 4 or higher, a pH of 5 or higher, a pH of 6 or higher, or a pH of 7 or higher. As such, the end-use formulation may have a pH of 4 or higher, 4.5 or higher, 5 or higher, 5.5 or higher, 6 or higher, 6.5 or higher, 7 or higher, 7.5 or higher, 8 or higher, 8.5 or higher, 9 or higher, 9.5 or higher, or 10 or higher. In one embodiment, the end-use formulation has a pH of from 4 to 9, preferably of from 6 to 8. In one embodiment, the end-use formulation has a pH of from 6 to 9, preferably of from 7 to 8.

In one embodiment, the preservative agent is present in the end-use formulation in an amount of from 1 wt.-% or less, such as in an amount of 0.5 wt.-% or less, based on the weight of the end-use formulation.

In general, the preservative composition of the present invention can be incorporated into any number of different end-use formulations or products. As used herein, “end-use formulation” is intended to include personal care products, cosmetics, home care products, and health and hygiene products. In one embodiment, the end-use formulation is a personal care product. For instance, personal care products may include products such as cosmetic formulations, including face creams, makeup removers, mascaras or wet wipes. The personal care product also includes shampoos, conditioners, skin lotions or liquids for any personal care wet wipe application. The personal care product can include any product for topical application to a users skin or hair. When the preservative compositions of the present invention are formulated into an end-use formulation, the preservative composition provides effective, broad spectrum preservation activity over a broad pH range, specifically at a pH of 4 or higher, at a pH of 5 or higher, or at a pH of 6 or higher, such as a pH of 4, 4.5, 5, 5.5, 6, 6.5, 7, 7.5, 8, 8.5, 9, 9.5, and 10 or higher. For instance, in certain embodiments, the end-use formulation, e.g. the personal care product, may have a pH ranging from about 4 to 10, such as about 6 to 10, such as from about 6 to about 8, particularly from about 6 to about 8 or from about 7 to about 8. Accordingly, the preservative composition of the present invention may exhibit broad antimicrobial coverage for an end-use formulation across a range of end-use formulations having a spectrum of pHs.

In embodiments, the preservative composition of the present invention may have a pH ranging from about 3 to 9, such as from about 4 to about 9, such as from about 5 to about 8, particularly from about 6 to about 8 or from about 7 to about 8.

The end-use formulation such as a personal care product may comprise a base formulation to which the preservative composition of the present invention is added. The base formulation may contain numerous and different ingredients depending upon the end use application. The end-use formulation, for instance, may contain solvents, surfactants, emulsifiers, consistency factors, conditioners, emollients, skin caring ingredients, moisturizers, thickeners, humectants, fillers, anti-oxidants, other preservatives, active ingredients, in particular dermatologically active ingredients, fragrances and the Ike, as well as mixtures thereof. Active ingredients as mentioned herein comprise, for example, anti-inflammatories, anti-bacterials, anti-fungals and the like agents. Active ingredients suited for topical applications are particularly preferred.

Suitable surfactants comprise: alkyl sulfates e.g. sodium lauryl sulfate, ammonium lauryl sulfate; sodium cetearyl sulfate; alkyl sulfoacetates e.g. sodium lauryl sulfoacetate; alkyl ether sulfates e.g. sodium laureth sulfate; sodium trideceth sulfate; sodium oleth sulfate; ammonium laureth sulfate; alkyl ether sulfosuccinates e.g. disodium laureth sulfosuccinate; alkyl glycosides e.g. decyl glucoside; lauryl glucoside; alkyl isethionates amphoterics e.g. cocamidopropyl betaine; sodium cocoamphoacetate; sodium lauroamphoacetate; disodium lauroamphodiacetate; disodium cocoamphodiacetate; sodium lauroamphopripionate; disodium lauroamphodipropionate; potassium or ammonium salts of the aforementioned amphoterics; capryVcaprarridopropyl betaine; undecylenamidopropyl betaine; lauromidopropyl betaine; and fatty alcohol polyglycol ethers.

Suitable emulsifiers include e.g. anionics as salts of fatty acids e.g. sodium stearate or sodium palmitate, organic soaps e.g. mono-, di- or triethanolarrinoeate, sulfated or sulfonated compounds e.g. sodium lauryl sulfate or sodium cetyl sulfonate, saponines, lamepones; cationics as quaternary ammonium salts; nonionics as fatty alcohols, fatty acid ester with saturated or unsaturated fatty acids, polyoxyethylenesters or polyoxyethylenethers of fatty acids, polymers from ethylene oxide and propylene oxide or propylene glycol, amphotherics as phosphatides, proteins as gelatine, casein alkylamidobetaines, alkyl betaines and amphoglycinates, alkyl phosphates, alkylpolyoxyethylene phosphates or the corresponding acids, silicone derivatives, e.g. alkyl dimethiconecoplyol.

Suitable consistency factors include e.g. fatty alcohols or their mixtures with fatty acid esters, e.g. acetylated lanolin alcohol, aluminum stearates, carbomer, cetyl alcohol, glyceryl oleate, glyceryl stearate, glyceryl stearate (and) PEG 100 stearate, magnesium stearate, magnesium sulfate, oleic acid, stearic acid, stearyl alcohol, myristyl myristate, isopropyl palmitate, beeswax and synthetic equivalents thereof, carbomers, and the Ike. Suitable conditioners are e.g. alkylamido ammonium lactate, cetrimonium chloride and distearoylethyl hydroxyethylmonium methosulfate and cetearyl alcohol, cetyl dimethicone, cetyl ricinoleate, dimethicone, laureth-23, laureth-4, polydecene, retinyl palmitate, quaternized protein hydrolysates, quaternized cellulose and starch derivatives, quaternized copolymers of acrylic or methacrylic acid or salts, quaternized silicone derivatives.

Suitable emollients include e.g. cetearyl isononanoate, cetearyl octanoate, decyl oleate, isooctyl stearate, coco caprylate/caprate, ethylhexyl hydroxystearate, ethylhexyl isononanoate, isopropyl isostearate, isopropyl myristate, oleyl oleate, hexyl laurate, paraffinum liquidum, PEG-75 lanolin, PEG-7 glyceryl cocoate, petrolatum, ozokerite cyclomethicone, dimethicone, dimethicone copolyol, dicaprylyl ether, butyrospermum parkii, Buxus chinensis, canola, Camauba cera, Copernicia cerifera, Oenothera biennis, Elaeis guineensis, Prunus dulcis, squalane, Zea mays, Glycine soja, Helianthus annuus, lanolin, hydrogenated castor oil, hydrogenated coconut oil, hydrogenated polyisobutene, sucrose cocoate, stearoxy dimethicone, lanolin alcohol, isohexadecane.

Suitable skin care ingredients include e.g. plant extracts, bisabolol, anti-inflammatory agents, urea, allantoin, panthenol and panthenol derivatives, phytantriol, vitamins A, E, C, D, ceramides of animal or plant origin, lecithins, and the Ike.

Suitable moisturizers include e.g. butylenes glycol, cetyl alcohol, dimethicone, dimyristyl tartrate, glucose glycereth-26, glycerin, glyceryl stearate, hydrolyzed milk protein, lactic acid, lactose and other sugars, laureth-8, lecithin, octoxyglycerin, PEG-12, PEG 135, PEG-150, PEG-20, PEG-8, pentylene glycol, hexylene glycol, phytantriol, poly quaternium-39 PPG-20 methyl glucose ether, propylene glycol, sodium hyaluronate, sodium lactate, sodium PCA, sorbitol, succinoglycan, synthetic beeswax, tri-C14-15 alkyl citrate, starch.

Suitable thickeners include e.g. acrylates/steareth-20 methacrylate copolymer, carbomer, carboxymethyl starch, cera alba, dimethicone/vinyl dimethicone crosspolymer, propylene glycol alginate, hydroxyethylcellulose, hydroxypropyl methylcellulose, silica, silica dimethyl silylate, xanthan gum, hydrogenated butylenes/ethylene/styrene copolymer.

Suitable humectants include e.g. adipic acid, fumaric acid and its salts, benzoic acid and its salts, glycerine triacetate, sodium or magnesium lauryl sulfate, magnesium stearate, solid polyethylenglycol, polyvinylpyrrolidone, boric acid, mono-laurate or mono-palmitate, myristyl alcohol, cetyl alcohol, cetylstearyl alcohol, talcum, calcium or magnesium salts of higher fatty acids, mono-, di- or triglycerides of higher fatty acids, polytetrafluorethylene.

Suitable antioxidants include e.g. sulfites, e.g. sodium sulfite, tocopherol or derivates thereof, ascorbic acid or derivates thereof, citric acid, propyl gallate, chitosan glycolate, cysteine, N-acetyl cysteine plus zinc sulfate, thiosulfates, e.g. sodium thiosulfate, polyphenols and the Ike.

The formulations and composition disclosed herein may further contain active ingredients, e.g. antimicrobials, anti-inflammatories, plant extracts, bisabolol, panthenol, tocopherol, actives for anti-stinging, anti-irritant or anti-dandruff applications, or anti-aging agents such as retinol, melibiose and the Ike. Other suitable actives include e.g. Medicago officinalis, Actinidia chinensis, Allantoin, Aloe barbadensis, Anona cherimolia, Anthemis nobils, Arachis hypogaea, Amica Montana, Avena sativa, beta-carotene, bisabolol, Borago officinalis, butylenes glycol, Calendula officinalis, Camellia sinensis, camphor, Candida bombicola, capryloyl glycine, Carica papaya, Centaurea cyanus, Cetylpyridinium chloride, Chamomilla recutita, Chenopodium quinoa, Chinchona succirubra, Chondrus crispus, Citrus aurantium dulcis, Citrus grandis, Citrus limonum, Cocos nucifera, Coffea Arabica, Crataegus monogina, Cucumis melo, Dichlorophenyl imidazoldioxolan, Enteromorpha compressa, Equisetum arvense, ethoxydiglycol, ethyl panthenol, famesol, ferulic acid, Fragaria chiloensis, Gentiana lutea, Ginkgo biloba, glycerin, glyceryl laurate, Glycyrrhiza glabra, Hamamels virginiana, heliotropine, hydrogenated palm glycerides, citrates, hydrolyzed castor oil, hydrolyzed wheat protein, Hypericum perforatum, Iris florentina, Juniperus communis, Lactis proteinum, lactose, Lawsonia inermis, linalool, Linum usitatissimum, lysine, magnesium aspartate, Magnifera indica, Malva sylvestris, mannitol, Melaleuca altemifolia, Mentha piperita, menthol, menthyl lactate, Mimosa tenuiflora, Nymphaea alba, olaflur, Oryza sativa, panthenol, paraffinum iquidum, PEG-20M, PEG-26 jojoba acid, PEG-26 jojoba alcohol, PEG-35 castor oil, PEG-40 hydrogenated castor oil, PEG-60 hydrogenated castor oil, PEG-8 caprylic/capric acid, Persea gratissima, petrolatum, potassium aspartate, potassium sorbate, propylene glycol, Prunus amygdalus dulcis, Prunus armeniaca, Prunus persica, retinyl palmitate, Ricinus communis, Rosa canina, Rosmarinus officinalis, Rubus idaeus, salicylic acid, Sambucus nigra, sarcosine, Serenoa serrulata, Simmondsia chinensis, sodium carboxymethyl betaglucan, sodium cocoyl amino acids, sodium hyaluronate, sodium palmitoyl praline, stearoxytrimethylsilane, stearyl alcohol, sulfurized TEA-ricinoleate, talc, Thymus vulgaris, Tila cordata, tocopherol, tocopheryl acetate, trideceth-9, Triticum vulgare, tyrosine, undecylenoyl glycine, urea, Vaccinium myrtillus, valine, zinc oxide, zinc sulfate.

The preservative composition of the present invention can be used in emulsions (both oil-in-water and water-in-oil), in aqueous solutions, in PIT (phase inversion temperature) emulsions, in oily solutions, in foaming cosmetic formulations (foams), and in so-called multiple emulsions, e.g. in triple emulsions (such as water/oil/water emulsions).

The preservative composition of the present invention can also be added to an end-use formulations such as creams, gels, liquids or lotions. They can be used in hair care products such as shampoos, hair conditioners, hair dyes, hair tonic, hair gel, hair dressings, hair grooming aids and other hair care preparations; shaving applications such as shaving cream, aftershave lotions, and other shaving applications; personal cleaners for the body and hands, such as liquid bath soaps and detergents; fragrance preparations, such as perfumes, after bath splashes, and other similar fragrant preparations, skin care products, such as moisturizers, creams, and lotions and other similar skin care products, make-up products, such as mascara, base foundations and the Ike; make-up removal products, sun care products, indoor tanning products and other similar personal care products. In certain embodiments, the preservative composition disclosed herein may be incorporated in formulations used to saturate wipes, used for personal cleaning and hygiene (for example baby wipes, wet toilet wipes, make-up removal wipes and exfoliating wipes the Ike. The preservative composition may also be used in other formulations where preservative agents are needed. The above-exemplified products are all intended to be understood as an end-use formulation in the context of the present invention.

In some embodiments, the preservative composition of the present invention may be added to an end-use formulation in an amount of from 0.01% to about 5% by weight based on the total weight of the end-use formulation. More particularly, in some embodiments the preservative composition is added in an amount of from 0.1% to about 3% by weight based on the total weight of the end-use formulation. The amount of the preservative composition added may be dependent on the preservative agent selected.

The present invention further pertains to the use of the preservative composition according to the present invention for increasing the efficacy against microorganisms compared to an equal amount of the preservative agent without the at least one levulinic acid derivative.

The present invention further pertains to the use of at least one levulinic acid derivative selected from (a) a levulinic acid ester, or (b) a levulinic ketal, and combinations thereof for increasing the efficacy of at least one preservative agent against microorganisms compared to an equal amount of the preservative agent without the at least one levulinic acid derivative.

In one embodiment, the efficacy against microorganisms is increased at a pH of 4 to 9 or higher compared to an equal amount of the preservative agent at a pH of 4 to 9 without the at least one levulinic acid derivative. Preferably, the efficacy against microorganisms is increased at a pH of 6 to 8 or higher compared to an equal amount of the preservative agent at a pH of 6 to 8 without the at least one levulinic acid derivative.

In one embodiment, the efficacy is increased by at least 0.5 log reduction. In one embodiment, the efficacy is increased by at least 1.0 log reduction.

The present invention further pertains to a method for preventing an end-use formulation from spoilage by microorganisms, the method comprising adding the preservative composition according the invention to the end-use formulation. In one embodiment, the end-use formulation has a pH of 4 or higher, preferably a pH of 6 or higher.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention. All embodiments and preferred embodiments described herein in connection with one particular aspect of the invention (e.g. the inventive preservative composition) shall likewise apply to all other aspects of the present inventions such as end-use formulations, uses or methods according to the present invention.

The present invention will be further illustrated by the following examples. All parts and percentages provided are by weight unless otherwise indicated.

### EXAMPLES

### Example 1

Preservative effect of butyl levulinate in combination with sodium benzoate in sterile distilled water (“SDW”, pH 7). The pH was adjusted using Sodium Hydroxide and Citric Acid Monohydrate.

### Method:

In the following example, the following test organisms were used:
Pseudomonas aeruginosa ATCC 9027
Aspergillus brasiliensis ATCC 16404

### Test Organism Preparation

### Conditions for the Growth of Inocula:

| | | Temp | | |
|---|---|---|---|---|
| Micro-organisms | Agar | (° C.) | Time | |
| Pseudomonas aeruginosa ATCC 9027 | TSA | 30 ± 2 | 18-48 | hours |
| Aspergillus brasiliensis ATCC 16404 | MEA | 27.5 ± 2.5 | 7-9 | days |

Bacteria were harvested and prepared in diluent (sterile distilled water) to obtain a final concentration of 1.0×10⁶ to 5.0×10⁶ cfu/ml.

Yeast strains were harvested and prepared in diluent (sterile distilled water) to obtain a final concentration of 1.0×10⁵ to 1.0×10⁶ cfu/ml.

Mould strain spores were harvested (sterile distilled water+0.05% polysorbate 80) and treated to remove fungal hyphae. Mould strain spores were prepared in diluent (sterile distilled water) to obtain a final concentration of 1.0×10⁵ to 1.0×10⁵ cfu/ml.

### Test Sample Preparation

Samples were prepared for testing according to the following table:

| Test | | Conc | Preservative | Conc | |
|---|---|---|---|---|---|
| Sample | Potentiator | (ppm) | agent | (ppm) | Matrices |
| 1 | Butyl Levulinate | 500 | Sodium benzoate | 0 | SDW (pH 7) |
| 2 | Butyl Levulinate | 1000 | Sodium benzoate | 0 | SDW (pH 7) |
| 3 | Butyl Levulinate | 1500 | Sodium benzoate | 0 | SDW (pH 7) |
| 4 | Butyl Levulinate | 2000 | Sodium benzoate | 0 | SDW (pH 7) |
| 5 | Butyl Levulinate | 2500 | Sodium benzoate | 0 | SDW (pH 7) |
| 6 | Butyl Levulinate | 0 | Sodium benzoate | 5000 | SDW (pH 7) |
| 7 | Butyl Levulinate | 500 | Sodium benzoate | 5000 | SDW (pH 7) |
| 8 | Butyl Levulinate | 1000 | Sodium benzoate | 5000 | SDW (pH 7) |
| 9 | Butyl Levulinate | 1500 | Sodium benzoate | 5000 | SDW (pH 7) |
| 10 | Butyl Levulinate | 2000 | Sodium benzoate | 5000 | SDW (pH 7) |
| 11 | Butyl Levulinate | 2500 | Sodium benzoate | 5000 | SDW (pH 7) |
| 12 | Butyl Levulinate | 0 | Sodium benzoate | 10000 | SDW (pH 7) |
| 13 | Butyl Levulinate | 500 | Sodium benzoate | 10000 | SDW (pH 7) |
| 14 | Butyl Levulinate | 1000 | Sodium benzoate | 10000 | SDW (pH 7) |
| 15 | Butyl Levulinate | 1500 | Sodium benzoate | 10000 | SDW (pH 7) |
| 16 | Butyl Levulinate | 2000 | Sodium benzoate | 10000 | SDW (pH 7) |
| 17 | Butyl Levulinate | 2500 | Sodium benzoate | 10000 | SDW (pH 7) |
| 18 | Butyl Levulinate | 0 | Sodium benzoate | 15000 | SDW (pH 7) |
| 19 | Butyl Levulinate | 500 | Sodium benzoate | 15000 | SDW (pH 7) |
| 20 | Butyl Levulinate | 1000 | Sodium benzoate | 15000 | SDW (pH 7) |
| 21 | Butyl Levulinate | 1500 | Sodium benzoate | 15000 | SDW (pH 7) |
| 22 | Butyl Levulinate | 2000 | Sodium benzoate | 15000 | SDW (pH 7) |
| 23 | Butyl Levulinate | 2500 | Sodium benzoate | 15000 | SDW (pH 7) |
| 24 | Butyl Levulinate | 0 | Sodium benzoate | 20000 | SDW (pH 7) |
| 25 | Butyl Levulinate | 500 | Sodium benzoate | 20000 | SDW (pH 7) |
| 26 | Butyl Levulinate | 1000 | Sodium benzoate | 20000 | SDW (pH 7) |
| 27 | Butyl Levulinate | 1500 | Sodium benzoate | 20000 | SDW (pH 7) |
| 28 | Butyl Levulinate | 2000 | Sodium benzoate | 20000 | SDW (pH 7) |
| 29 | Butyl Levulinate | 2500 | Sodium benzoate | 20000 | SDW (pH 7) |
| 30 | Butyl Levulinate | 0 | Sodium benzoate | 25000 | SDW (pH 7) |
| 31 | Butyl Levulinate | 500 | Sodium benzoate | 25000 | SDW (pH 7) |
| 32 | Butyl Levulinate | 1000 | Sodium benzoate | 25000 | SDW (pH 7) |
| 33 | Butyl Levulinate | 1500 | Sodium benzoate | 25000 | SDW (pH 7) |
| 34 | Butyl Levulinate | 2000 | Sodium benzoate | 25000 | SDW (pH 7) |
| 35 | Butyl Levulinate | 2500 | Sodium benzoate | 25000 | SDW (pH 7) |

### Test Procedure

Preservation efficacy testing started at Day 0 (t=0). Each sample was inoculated at t=0 with a known concentration of micro-organism. Each inoculated sample was then mixed until a homogenous mixture was obtained. Inoculated samples were stored in the dark at 22.5±2.5° C. throughout the test period.

### Assessment of Antimicrobial Activity.

At the specified contact time of 7 days (t=7), test samples were deactivated by adding a 0.1 ml aliquot of the test sample to 0.9 ml of an appropriate neutralising broth. The solution was left for 15 minutes. Subsequent dilutions were prepared by serial dilution of 0.1 ml into 0.9 ml of neutralising broth. Bacteria were serially diluted to 10⁻⁴, Fungi were serially diluted to 10⁻³.

### Drop Plate Method.

Each serial dilution was thoroughly mixed and 25 μl drops were aliquoted onto the surface of pre-prepared agar plates. Plates were prepared in sextupicate for each sample dilution.

The agar plates were allowed to dry, then inverted and incubated under conditions appropriate for the test microorganisms.

CFU/ml was calculated taking into account dilution factors. Colonies from the incubated plates were enumerated using the lower count limit of <10 CFU/ml and the upper count limit of >330 CFU/ml.

The lower and upper limits for drop plating were only employed on the highest and lowest dilution factor plates.

### Results

P. aeruginosa

| | | Sodium Benzoate Concentration | | | | | |
|---|---|---|---|---|---|---|---|
| P. aeruginosa (7 days - pH 7) | | 0 | 5000 | 10000 | 15000 | 20000 | 25000 |
| Stock- 7.60 × 10⁶ | | ppm | ppm | ppm | ppm | ppm | ppm |
| Butyl Levulinate | 0 ppm | — | 1.73 | >4.90 | >4.90 | >4.90 | >4.90 |
| Concentration | 1500 ppm | <0.38 | >4.90 | >4.90 | >4.90 | >4.90 | >4.90 |
| | 2000 ppm | <0.38 | >4.90 | >4.90 | >4.90 | >4.90 | >4.90 |
| | 2500 ppm | <0.38 | >4.90 | >4.90 | >4.90 | >4.90 | >4.90 |

A. brasiliensis

| | | Sodium Benzoate Concentration | | | | | |
|---|---|---|---|---|---|---|---|
| A. brasiliensis (7 days - pH 7) | | 0 | 5000 | 10000 | 15000 | 20000 | 25000 |
| Stock- 3.40 × 10⁵ | | ppm | ppm | ppm | ppm | ppm | ppm |
| Butyl Levulinate | 0 ppm | — | 2.09 | 2.14 | 2.20 | 2.33 | 3.11 |
| Concentration | 500 ppm | 1.90 | 2.31 | 1.97 | 1.96 | 2.67 | 3.41 |
| | 1000 ppm | 1.82 | 2.22 | 2.41 | 2.48 | 2.93 | >3.53 |
| | 1500 ppm | 1.85 | 2.41 | 2.18 | 2.53 | >3.53 | >3.53 |
| | 2000 ppm | 2.01 | 2.29 | 2.39 | 3.11 | >3.53 | >3.53 |
| | 2500 ppm | 1.80 | 2.22 | 2.29 | 3.11 | >3.53 | >3.53 |

Sodium benzoate potentiation was observed by butyl levulinate against bacteria and mould in a sterile distilled water matrix at pH 7.

### Example 2

Preservative effect of butyl levulinate in combination with sodium benzoate in sterile distilled water (pH 8). The pH was adjusted using sodium hydroxide and citric acid monohydrate.

### Method:

The test organisms were prepared and the method was performed according to the protocol of Example 1.

### Results

P. aeruginosa

| | | Sodium Benzoate Concentration | | | | | |
|---|---|---|---|---|---|---|---|
| P. aeruginosa (7 days - pH 8) | | 0 | 5000 | 10000 | 15000 | 20000 | 25000 |
| Stock- 3.70 × 10⁶ | | ppm | ppm | ppm | ppm | ppm | ppm |
| Butyl Levulinate | 0 ppm | — | 1.54 | 1.36 | 1.57 | 3.20 | >4.57 |
| Concentration | 500 ppm | <0.05 | 0.60 | 1.36 | 1.72 | 3.70 | >4.57 |
| | 1000 ppm | <0.05 | <0.05 | 1.49 | 2.27 | >4.57 | >4.57 |
| | 1500 ppm | <0.05 | <0.05 | 1.11 | 4.14 | >4.57 | >4.57 |
| | 2000 ppm | <0.05 | <0.05 | 2.12 | >4.57 | >4.57 | >4.57 |
| | 2500 ppm | <0.05 | <0.05 | 4.44 | >4.57 | >4.57 | >4.57 |

A. brasiliensis

| | | Sodium Benzoate Concentration | | | | | |
|---|---|---|---|---|---|---|---|
| A. brasiliensis (7 days - pH 8) | | 0 | 5000 | 10000 | 15000 | 20000 | 25000 |
| Stock- 5.00 × 10⁴ | | ppm | ppm | ppm | ppm | ppm | ppm |
| Butyl Levulinate | 0 ppm | — | 0.33 | 0.70 | 0.64 | 0.60 | 0.55 |
| Concentration | 500 ppm | 0.64 | 0.44 | 0.73 | 0.80 | 0.62 | 0.55 |
| | 1000 ppm | 0.36 | 0.88 | 0.60 | 0.67 | 0.62 | 1.08 |
| | 1500 ppm | 0.36 | 0.34 | 0.64 | 0.49 | 0.70 | 1.11 |
| | 2000 ppm | 0.38 | 0.46 | 0.80 | 0.70 | 1.28 | 1.32 |
| | 2500 ppm | 0.33 | 0.67 | 0.49 | 0.70 | 1.28 | 1.76 |

Sodium benzoate potentiation was observed by butyl levulinate against bacteria and mould in a sterile distilled water matrix at pH 8.

### Example 3

Preservative effect of butyl levulinate in combination with IPBC in sterile distilled water (pH 7). The pH was adjusted using Sodium Hydroxide and Citric Acid Monohydrate.

### Method:

The test organism was prepared and the method was performed according to the protocol of Example 1.

### Results

A. brasiliensis

| | | IPBC Concentration | | | | | |
|---|---|---|---|---|---|---|---|
| A. brasiliensis (7 days - pH 7) | | 0 | 100 | 250 | 500 | 750 | 1000 |
| Stock- 1.83 × 10⁵ | | ppm | ppm | ppm | ppm | ppm | ppm |
| Butyl Levulinate | 0 ppm | — | 1.21 | 0.77 | 0.71 | 0.57 | 0.85 |
| Concentration | 500 ppm | 0.61 | 1.18 | 0.84 | 0.93 | 0.81 | 0.82 |
| | 1000 ppm | 0.60 | 1.23 | 1.16 | 1.04 | 0.82 | 0.96 |
| | 1500 ppm | 0.74 | 1.18 | 1.09 | 1.18 | 1.21 | 1.06 |
| | 2000 ppm | 0.70 | 1.36 | 1.36 | 1.21 | 1.06 | 2.09 |
| | 2500 ppm | 0.72 | 1.18 | 1.09 | 1.21 | 1.93 | 2.36 |

IPBC potentiation was observed by butyl levulinate against mould in a sterile distilled water matrix at pH 7.

### Example 4

Preservative effect of butyl levulinate in combination with potassium sorbate in sterile distilled water (pH 7). The pH was adjusted using Sodium Hydroxide and Citric Acid Monohydrate.

### Method:

The test organisms were prepared and the method was performed according to the protocol of Example 1.

### Results:

P. aeruginosa

| | | Potassium Sorbate Concentration | | | | | |
|---|---|---|---|---|---|---|---|
| P. aeruginosa (7 days - pH 7) | | 0 | 5000 | 10000 | 15000 | 20000 | 25000 |
| Stock- 3.58 × 10⁶ | | ppm | ppm | ppm | ppm | ppm | ppm |
| Butyl Levulinate | 0 ppm | — | <0.03 | <0.03 | <0.03 | >4.55 | >4.55 |
| Concentration | 500 ppm | <0.03 | <0.03 | <0.03 | <0.03 | >4.55 | >4.55 |
| | 1000 ppm | <0.03 | <0.03 | <0.03 | >4.55 | >4.55 | >4.55 |
| | 1500 ppm | <0.03 | <0.03 | >4.55 | >4.55 | >4.55 | >4.55 |
| | 2000 ppm | <0.03 | <0.03 | >4.55 | >4.55 | >4.55 | >4.55 |
| | 2500 ppm | <0.03 | <0.03 | >4.55 | >4.55 | >4.55 | >4.55 |

C. albicans

| | | Potassium Sorbate Concentration | | | | | |
|---|---|---|---|---|---|---|---|
| C. albicans (7 days - pH 7) | | 0 | 5000 | 10000 | 15000 | 20000 | 25000 |
| Stock- 2.33 × 10⁵ | | ppm | ppm | ppm | ppm | ppm | ppm |
| Butyl Levulinate | 0 ppm | — | 1.01 | 0.72 | 0.72 | 0.92 | 0.83 |
| Concentration | 500 ppm | 0.11 | 0.74 | 0.54 | 0.82 | 1.14 | 1.26 |
| | 1000 ppm | 0.22 | 0.78 | 0.67 | 0.75 | 1.24 | 2.50 |
| | 1500 ppm | 0.11 | 0.73 | 0.81 | 1.13 | >3.37 | >3.37 |
| | 2000 ppm | −0.11 | 0.91 | 0.83 | 1.24 | >3.37 | >3.37 |
| | 2500 ppm | 0.18 | 0.78 | 0.94 | 1.76 | >3.37 | >3.37 |

A. brasiliensis

| | | Potassium Sorbate Concentration | | | | | |
|---|---|---|---|---|---|---|---|
| A. brasiliensis (7 days - pH 7) | | 0 | 5000 | 10000 | 15000 | 20000 | 25000 |
| Stock- 1.10 × 10⁵ | | ppm | ppm | ppm | ppm | ppm | ppm |
| Butyl Levulinate | 0 ppm | — | 0.58 | 0.67 | 0.45 | 0.64 | 0.52 |
| Concentration | 500 ppm | 0.10 | 0.51 | 0.67 | 0.67 | 0.76 | 0.65 |
| | 1000 ppm | 0.10 | 0.69 | 0.76 | 0.86 | 0.76 | 0.96 |
| | 1500 ppm | 0.31 | 0.77 | 0.82 | 0.74 | 0.86 | 1.10 |
| | 2000 ppm | −0.01 | 0.69 | 0.77 | 0.77 | 0.92 | 1.10 |
| | 2500 ppm | 0.18 | 0.76 | 0.79 | 0.92 | 1.26 | 1.49 |

### Example 5

Preservative effect of butyl levulinate in combination with potassium sorbate in sterile distilled water (pH 8). The pH- was adjusted using Sodium Hydroxide and Citric Acid Monohydrate.

### Method:

The test organism was prepared and the method was performed according to the protocol of Example 1.

### Results:

P. aeruginosa

| | | Potassium Sorbate Concentration | | | | | |
|---|---|---|---|---|---|---|---|
| P. aeruginosa (7 days - pH 8) | | 0 | 5000 | 10000 | 15000 | 20000 | 25000 |
| Stock- 7.00 × 10⁶ | | ppm | ppm | ppm | ppm | ppm | ppm |
| Butyl Levulinate | 0 ppm | — | <0.33 | <0.33 | <0.33 | <0.33 | <0.33 |
| Concentration | 500 ppm | <0.33 | <0.33 | <0.33 | 0.56 | 0.56 | 2.85 |
| | 1000 ppm | <0.33 | <0.33 | <0.33 | 1.08 | 1.64 | 3.18 |
| | 1500 ppm | <0.33 | <0.33 | 0.93 | 1.74 | 2.97 | >4.85 |
| | 2000 ppm | <0.33 | 2.38 | 2.11 | 3.56 | 4.42 | >4.85 |
| | 2500 ppm | <0.33 | 3.53 | 3.66 | >4.85 | 3.98 | >4.85 |

### Example 6

The synergistic preservative effect of butyl levulinate in combination with sodium benzoate in Frame Formulation 1 (SLES+CapB shampoo formulation having pH 7) was tested.

### Method:

In the following example, the following test organisms was used:
Aspergillus brasiliensis ATCC 16404

### Test Organism Preparation

### Conditions for the Growth of Inocula:

| Micro-organism | Agar | Temp (° C.) | Time |
|---|---|---|---|
| Aspergillus brasiliensis ATCC 16404 | MEA | 27.5 ± 2.5 | 7-9 days |

Mould strain spores were harvested (sterile distilled water+0.05% polysorbate 80) and treated to remove fungal hyphae. Mould strain spores were prepared in diluent (sterile distilled water) to obtain a final concentration of 1.0×10⁷ to 1.0×10⁷ cfu/ml.

### Test Sample Preparation

Samples were prepared for testing according to the following table:

| | | Conc | | Conc | |
|---|---|---|---|---|---|
| Formulation | Potentiator | (ppm) | Preseverative | (ppm) | Matrices |
| 1 | None | 0 | None | 0 | Shampoo (pH 7) |
| 2 | Butyl Levulinate | 1250 | None | 0 | Shampoo (pH 7) |
| 3 | Butyl Levulinate | 2500 | None | 0 | Shampoo (pH 7) |
| 4 | Butyl Levulinate | 5000 | None | 0 | Shampoo (pH 7) |
| 5 | Butyl Levulinate | 0 | Sodium Benzoate | 6000 | Shampoo (pH 7) |
| 6 | Butyl Levulinate | 1250 | Sodium Benzoate | 6000 | Shampoo (pH 7) |
| 7 | Butyl Levulinate | 2500 | Sodium Benzoate | 6000 | Shampoo (pH 7) |
| 8 | Butyl Levulinate | 5000 | Sodium Benzoate | 6000 | Shampoo (pH 7) |
| 9 | Butyl Levulinate | 0 | Sodium Benzoate | 8000 | Shampoo (pH 7) |
| 10 | Butyl Levulinate | 1250 | Sodium Benzoate | 8000 | Shampoo (pH 7) |
| 11 | Butyl Levulinate | 2500 | Sodium Benzoate | 8000 | Shampoo (pH 7) |
| 12 | Butyl Levulinate | 5000 | Sodium Benzoate | 8000 | Shampoo (pH 7) |

| | % required | RM % active | % as is | 1 kg |
|---|---|---|---|---|
| SLES-2EO | 10 | 70 | 14.286 | 142.86 |
| CAPB | 2 | 34.2 | 5.848 | 58.48 |
| Glycerine | 0.5 | 100 | 0.5 | 5 |
| NaCl | 1 | 100 | 1 | 10 |
| NaOH/Citric | Adjust to | | | 0 |
| Acid | req'd pH | | | |
| DI Water | To 100% | 100 | 78.366 | 783.66 |

### Test Procedure

Preservation efficacy testing started at Day 0 (t=0). Each sample was inoculated at t=0 with a known concentration of micro-organism at a volume of <1%. Each inoculated sample was then mixed until a homogenous mixture was obtained. Inoculated samples were stored in the dark at 22.5±2.5° C. throughout the test period.

### Assessment of Antimicrobial Activity.

At the specified contact time (t=7, 14, 28), test samples were deactivated by adding a 1 ml aliquot of the test sample to 9 ml of an appropriate neutralising broth. The solution was left for 15 minutes. Subsequent dilutions were prepared by serial dilution of 1 ml into 9 ml of neutralising broth. All samples were serially diluted to 10³.

### Pour Plate Method.

Each serial dilution was thoroughly mixed and 1 ml was aliquoted into a sterile petri dish. 20-25 ml of suitable agar were poured into each petri dish. Plates were prepared in duplicate for each for each sample dilution.

The agar plates were allowed to dry, then inverted and incubated under conditions appropriate for the test microorganism.

CFU/mi was calculated taking into account dilution factors. Colonies from the incubated plates were enumerated using the lower count limit of <10 CFU/ml and the upper count limit of >330 CFU/mi.

### Results

Log reduction was calculated for each experiment by the difference in recovery between the test formulations and initial stock concentrations.

A. brasiliensis

| | Log Reduction | | |
|---|---|---|---|
| Formulation | Day 7 | Day 14 | Day 28 |
| 1 | 1.26 | 1.29 | 1.30 |
| 2 | 1.23 | 1.17 | 2.31 |
| 3 | 1.43 | 1.41 | 2.83 |
| 4 | 1.36 | 1.38 | >2.98 |
| 5 | 1.58 | 1.14 | 2.41 |
| 6 | 1.64 | 1.64 | 2.55 |
| 7 | 2.33 | 2.25 | >2.98 |
| 8 | >2.98 | >2.98 | >2.98 |
| 9 | 1.52 | 1.40 | 2.20 |
| 10 | 2.56 | 2.55 | >2.98 |
| 11 | 2.58 | 2.73 | >2.98 |
| 12 | >2.98 | >2.98 | >2.98 |

Sodium benzoate potentiation was observed by butyl levulinate against A. brasiliensis in Frame Formulation 1 (SLES+CapB shampoo formulation) having pH 7.

### Example 7

The synergistic activity of ethyl levulinate and butyl levulinate and preservative agents are demonstrated as part of two-component compositions.

A wide range of concentrations were tested against Pseudomonas aeruginosa, Staphylococcus aureus, Escherichia coli, and Candda albicans.

The lowest concentration of each mixture or single compound which prevents an observable level of growth was determined to be the minimum inhibitory concentration (MIC) value.

Serial dilutions of each mixture or single compound were prepared. Micro-organisms were inoculated into media: Nutrient Broth (bacteria) or Malt Extract Broth (yeast). The final concentrations of micro-organisms in media was approximately 10⁵⁻⁶ CFU/ml. The inoculated media was introduced to each of the serial dilutions at a 1:1 ratio, and incubated at 30±1° C. for 24-48 hours.

The MICs for each mixture was compared with the MIC of each single compound alone.

Synergy was determined using the Kull equation (F. C. Kull et. al., “Mixtures of Quaternary Ammonium Compounds and Long-chain Fatty Acids as Antifungal Agents”, Appl Microbiol. 1961 November; 9(6): 538-541), which calculates a Synergy Index (SI) according the following equation:

$$SI = Qa / QA + Qb / QB$$

wherein
QA=concentration of compound A in ppm, acting alone produced an end point,
Qa=concentration of compound A in ppm, in the mixture, which produced an end point,
QB=concentration of compound B in ppm, acting alone produced an end point, and
Qb=concentration of compound B in ppm, in the mixture, which produced an end point;

In this study the end point is measured by the MIC.

Synergy is demonstrated by an SI value of less than 1. An additive effect is demonstrated by an SI value of equal to 1. Antagonism is demonstrated by an SI value of greater than 1

Initial concentrations of each single compound was prepared as follows:

| | Starting | |
|---|---|---|
| | Concen- | |
| | tration | |
| Compound | (ppm) | Matrices/diluent |
| Sodium Benzoate | 15000 | Sterile Distilled water |
| Potassium Sorbate | 10000 | Sterile Distilled water |
| Lactic Acid | 10000 | Sterile Distilled water |
| Dehydroacetic Acid (DHA) | 2000 | Sterile Distilled water |
| Benzisothiazolinone (BIT) | 250 | Sterile Distilled water |
| Trisodium dicarboxymethyl | 5000 | Sterile Distilled water |
| alaninate (MGDA) | | |
| 2-hydroxypyridine-N-oxide | 2000 | Sterile Distilled water |
| ADBAC (Barquat BAC-50) | 125 | |
| Sodium Pyrithione | 250 | Sterile Distilled water |
| Poly(hexamethylene) | 5000 | Sterile Distilled water |
| biguanide (PHMB) | | |
| Ethyl Levulinate | 25000 | Sterile Distilled water |
| Butyl Levulinate | 12500 | Sterile Distilled water + |
| | | PEG 40 Hydrogenated Castor |
| | | Oil (12500 ppm) |

### (1) Synergistic Interaction Between Ethyl Levulinate and Preservative Agents

Pseudomonas aeruginosa

### ADBAC (Barquat BAC-50)

| | MIC (ppm) to inhibit growth | | |
|---|---|---|---|
| Active weight ratio of Ethyl | Ethyl | | Synergy |
| levulinate:ADBAC | levulinate | ADBAC | index |
| Ethyl levulinate alone | 12500 | 0 | |
| 1600:1 | 6250 | 4 | 0.75 |
| ADBAC alone | 0 | 16 | |

### Sodium Pyrithione

| | MIC (ppm) to inhibit growth | | |
|---|---|---|---|
| Active weight ratio of Ethyl | Ethyl | Sodium | Synergy |
| levulinate:Sodium Pyrithione | levulinate | Pyrithione | index |
| Ethyl levulinate alone | 12500 | 0 | |
| 6400:1 | 6250 | <1 | 0.52 |
| 3200:1 | 6250 | 2 | 0.53 |
| 1600:1 | 6250 | 4 | 0.56 |
| | 3125 | 2 | 0.28 |
| 800:1 | 6250 | 8 | 0.63 |
| | 3125 | 4 | 0.31 |
| | 1563 | 2 | 0.16 |
| 400:1 | 6250 | 16 | 0.75 |
| | 3125 | 8 | 0.38 |
| | 1563 | 4 | 0.19 |
| 200:1 | 3125 | 16 | 0.50 |
| | 1563 | 8 | 0.25 |
| 100:1 | 3125 | 31 | 0.75 |
| | 1563 | 16 | 0.38 |
| 50:1 | 1563 | 31 | 0.63 |
| | 781 | 16 | 0.31 |
| 25:1 | 781 | 31 | 0.56 |
| 25:2 | 391 | 31 | 0.53 |
| 25:4 | 195 | 31 | 0.52 |
| Sodium Pyrithione alone | 0 | 63 | |

Staphytococcus aureus

### Sodium Benzoate

| | MIC (ppm) to inhibit growth | | |
|---|---|---|---|
| Active weight ratio of Ethyl | Ethyl | Sodium | Synergy |
| levulinate:Sodium benzoate | levulinate | benzoate | index |
| Ethyl levulinate alone | 25000 | 0 | |
| 10:3 | 12500 | 3750 | 0.75 |
| 1:5 | 1562 | 7500 | 0.56 |
| 1:10 | 781 | 7500 | 0.53 |
| 1:19 | 390 | 7500 | 0.52 |
| Sodium Benzoate alone | 0 | 15000 | |

### Potassium Sorbate

| | MIC (ppm) to inhibit growth | | |
|---|---|---|---|
| Active weight ratio of Ethyl | Ethyl | Potassium | Synergy |
| levulinate:Potassium Sorbate | levulinate | Sorbate | index |
| Ethyl levulinate alone | 12500 | 0 | |
| 320:1 | 6250 | 20 | 0.63 |
| 160:1 | 6250 | 39 | 0.75 |
| 40:1 | 3125 | 78 | 0.75 |
| 20:1 | 1563 | 78 | 0.63 |
| 10:1 | 781 | 78 | 0.56 |
| 5:1 | 390 | 78 | 0.53 |
| Potassium Sorbate alone | 0 | 156 | |

### Lactic Acid

| | MIC (ppm) to inhibit growth | | |
|---|---|---|---|
| Active weight ratio of Ethyl | Ethyl | Lactic | Synergy |
| levulinate:Lactic Acid | levulinate | Acid | index |
| Ethyl levulinate alone | 12500 | 0 | |
| 40:1 | 3125 | 78 | 0.75 |
| 20:1 | 1563 | 78 | 0.63 |
| 10:1 | 781 | 78 | 0.56 |
| Lactic Acid alone | 0 | 156 | |

Escherichia coli

### Sodium Benzoate

| | MIC (ppm) to inhibit growth | | |
|---|---|---|---|
| Active weight ratio of Ethyl | Ethyl | Sodium | Synergy |
| levulinate:Sodium benzoate | levulinate | benzoate | index |
| Ethyl levulinate alone | 25000 | 0 | |
| 40:3 | 12500 | 938 | 0.63 |
| 20:3 | 12500 | 1875 | 0.75 |
| 5:3 | 6250 | 3750 | 0.75 |
| 5:6 | 3125 | 3750 | 0.63 |
| Sodium Benzoate alone | 0 | 7500 | |

Candida albicans

### Sodium Benzoate

| | MIC (ppm) to inhibit growth | | |
|---|---|---|---|
| Active weight ratio of Ethyl | Ethyl | Sodium | Synergy |
| levulinate:Sodium benzoate | levulinate | benzoate | index |
| Ethyl levulinate alone | 25000 | 0 | |
| 40:3 | 12500 | 938 | 0.63 |
| 20:3 | 12500 | 1875 | 0.75 |
| 5:3 | 6250 | 3750 | 0.75 |
| Sodium Benzoate alone | 0 | 7500 | |

### Potassium Sorbate

| | MIC (ppm) to inhibit growth | | |
|---|---|---|---|
| Active weight ratio of Ethyl | Ethyl | Potassium | Synergy |
| levulinate:Potassium Sorbate | levulinate | Sorbate | index |
| Ethyl levulinate alone | 25000 | 0 | |
| 20:1 | 12500 | 625 | 0.75 |
| Potassium Sorbate alone | 0 | 2500 | |

### Lactic Acid

| | MIC (ppm) to inhibit growth | | |
|---|---|---|---|
| Active weight ratio of Ethyl | Ethyl | Lactic | Synergy |
| levulinate:Lactic Acid | levulinate | Acid | index |
| Ethyl levulinate alone | 25000 | 0 | |
| 20:1 | 12500 | 625 | 0.56 |
| 10:1 | 12500 | 1250 | 0.63 |
| 5:1 | 12500 | 2500 | 0.75 |
| 5:4 | 6250 | 5000 | 0.75 |
| 5:8 | 3125 | 5000 | 0.63 |
| 5:16 | 1563 | 5000 | 0.56 |
| Lactic Acid alone | 0 | 10000 | |

### ADBAC (Barquat BAC-50)

| | MIC (ppm) to inhibit growth | | |
|---|---|---|---|
| Active weight ratio of Ethyl | Ethyl | | Synergy |
| levulinate:ADBAC | levulinate | ADBAC | index |
| Ethyl levulinate alone | 25000 | 0 | |
| 6400:1 | 12500 | 2 | 0.75 |
| 1600:1 | 6250 | 4 | 0.75 |
| 800:1 | 3125 | 4 | 0.63 |
| ADBAC alone | 0 | 8 | |

### Sodium Pyrithione

| | MIC (ppm) to inhibit growth | | |
|---|---|---|---|
| Active weight ratio of Ethyl | Ethyl | Sodium | Synergy |
| levulinate:Sodium Pyrithione | levulinate | Pyrithione | index |
| Ethyl levulinate alone | 25000 | 0 | |
| 3200:1 | 12500 | 4 | 0.63 |
| 1600:1 | 12500 | 8 | 0.75 |
| 800:1 | 6250 | 8 | 0.50 |
| 400:1 | 6250 | 16 | 0.75 |
| | 3125 | 8 | 0.38 |
| 200:1 | 3125 | 16 | 0.63 |
| 100:1 | 1563 | 16 | 0.56 |
| Sodium Pyrithione alone | 0 | 31 | |

### (2) Synergistic Interaction Between Butyl Levulinate and Preservative Agents

Pseudomonas aeruginosa

### Lactic Acid

| | MIC (ppm) to inhibit growth | | |
|---|---|---|---|
| Active weight ratio of Butyl | Butyl | Lactic | Synergy |
| levulinate:Lactic Acid | levulinate | Acid | index |
| Butyl levulinate alone | 6250 | 0 | |
| 5:1 | 1563 | 313 | 0.75 |
| 5:2 | 781 | 313 | 0.63 |
| 5:4 | 391 | 313 | 0.56 |
| Lactic Acid alone | 0 | 625 | |

### Trisodium Dicarboxymethyl Alaninate (MGDA)

| | MIC (ppm) to inhibit growth | | |
|---|---|---|---|
| Active weight ratio of Butyl | Butyl | | Synergy |
| levulinate:MGDA | levulinate | MGDA | index |
| Butyl levulinate alone | 6250 | 0 | |
| 5:4 | 1563 | 1250 | 0.75 |
| 5:8 | 781 | 1250 | 0.63 |
| MGDA alone | 0 | 625 | |

### Sodium Pyrithione

| | MIC (ppm) to inhibit growth | | |
|---|---|---|---|
| Active weight ratio of Butyl | Butyl | Sodium | Synergy |
| levulinate:Sodium pyrithione | levulinate | pyrithione | index |
| Butyl levulinate alone | 6250 | 0 | |
| 6400:1 | 3125 | 0.5 | 0.51 |
| 3200:1 | 3125 | 1 | 0.52 |
| 1600:1 | 3125 | 2 | 0.53 |
| 800:1 | 3125 | 4 | 0.56 |
| | 1563 | 2 | 0.28 |
| 400:1 | 3125 | 8 | 0.63 |
| | 1563 | 4 | 0.31 |
| 200:1 | 3125 | 16 | 0.75 |
| | 1563 | 8 | 0.38 |
| 100:1 | 1563 | 16 | 0.50 |
| | 781 | 8 | 0.25 |
| 50:1 | 1563 | 31 | 0.75 |
| | 781 | 16 | 0.38 |
| 25:1 | 781 | 31 | 0.63 |
| | 390 | 16 | 0.31 |
| 25:2 | 390 | 31 | 0.56 |
| | 195 | 16 | 0.28 |
| 25:4 | 195 | 31 | 0.53 |
| Sodium pyrithione alone | 0 | 63 | |

Staphytococcus aureus

### Sodium Benzoate

| | MIC (ppm) to inhibit growth | | |
|---|---|---|---|
| Active weight ratio of Butyl | Butyl | Sodium | Synergy |
| levulinate:Sodium benzoate | levulinate | benzoate | index |
| Butyl levulinate alone | 25000 | 0 | |
| 5:3 | 6250 | 3750 | 0.50 |
| 2:5 | 3125 | 7500 | 0.63 |
| 1:5 | 1563 | 7500 | 0.56 |
| 1:10 | 781 | 7500 | 0.53 |
| 1:20 | 390 | 7500 | 0.52 |
| 1:40 | 195 | 7500 | 0.51 |
| Sodium benzoate alone | 0 | 15000 | |

Escherichia coli

### Sodium Benzoate

| | MIC (ppm) to inhibit growth | | |
|---|---|---|---|
| Active weight ratio of Butyl | Butyl | Sodium | Synergy |
| levulinate:Sodium benzoate | levulinate | benzoate | index |
| Butyl levulinate alone | 3125 | 0 | |
| 5:3 | 6250 | 3750 | 0.50 |
| 2:5 | 3125 | 7500 | 0.63 |
| 1:5 | 1563 | 7500 | 0.56 |
| 1:10 | 781 | 7500 | 0.53 |
| 1:20 | 390 | 7500 | 0.52 |
| 1:40 | 195 | 7500 | 0.51 |
| Sodium benzoate alone | 0 | 7500 | |

### Dehydroacetic Acid (DHA)

| | MIC (ppm) to inhibit growth | | |
|---|---|---|---|
| Active weight ratio of Butyl | Butyl | | Synergy |
| levulinate:DHA | levulinate | DHA | index |
| Butyl levulinate alone | 3125 | 0 | |
| 3:2 | 1563 | 1000 | 0.70 |
| 4:5 | 1563 | 2000 | 0.90 |
| | 781 | 1000 | 0.45 |
| 2:5 | 781 | 2000 | 0.65 |
| DHA alone | 0 | 5000 | |

Candida albicans

### Sodium Benzoate

| | MIC (ppm) to inhibit growth | | |
|---|---|---|---|
| Active weight ratio of Butyl | Butyl | Sodium | Synergy |
| levulinate:Sodium benzoate | levulinate | benzoate | index |
| Butyl levulinate alone | 6250 | 0 | |
| 10:3 | 3125 | 938 | 0.63 |
| 5:3 | 3125 | 1875 | 0.75 |
| 2:5 | 1562 | 3750 | 0.75 |
| 1:5 | 781 | 3750 | 0.63 |
| Sodium benzoate alone | 0 | 7500 | |

### Potassium Sorbate

| | MIC (ppm) to inhibit growth | | |
|---|---|---|---|
| Active weight ratio of Butyl | Butyl | Potassium | Synergy |
| levulinate:Potassium Sorbate | levulinate | Sorbate | index |
| Butyl levulinate alone | 6250 | 0 | |
| 20:1 | 3125 | 156 | 0.56 |
| 10:1 | 3125 | 313 | 0.63 |
| 5:1 | 3125 | 625 | 0.75 |
| 5:2 | 1563 | 625 | 0.50 |
| 5:4 | 1563 | 1250 | 0.75 |
| 5:8 | 781 | 1250 | 0.63 |
| Potassium Sorbate alone | 0 | 2500 | |

Dehydroacetic acid (DHA)

| | MIC (ppm) to inhibit growth | | |
|---|---|---|---|
| Active weight ratio of Butyl | Butyl | | Synergy |
| levulinate:DHA | levulinate | DHA | index |
| Butyl levulinate alone | 6250 | 0 | |
| 100:1 | 3125 | 31 | 0.63 |
| 50:1 | 3125 | 63 | 0.75 |
| 25:1 | 1563 | 63 | 0.50 |
| 25:2 | 781 | 63 | 0.38 |
| | 1562 | 125 | 0.75 |
| 25:4 | 781 | 125 | 0.63 |
| 25:8 | 390 | 125 | 0.56 |
| 25:16 | 195 | 125 | 0.53 |
| DHA alone | 0 | 250 | |

### Benzisothiazolinone (BIT)

| | MIC (ppm) to inhibit growth | | |
|---|---|---|---|
| Active weight ratio of Butyl | Butyl | | Synergy |
| levulinate:BIT | levulinate | BIT | index |
| Butyl levulinate alone | 6250 | 0 | |
| 100:1 | 1563 | 16 | 0.75 |
| BIT alone | 0 | 31 | |

2-hydroxyuridine-N-oxide (HPNO)

| | MIC (ppm) to inhibit growth | | |
|---|---|---|---|
| Active weight ratio of Butyl | Butyl | | Synergy |
| levulinate:HPNO | levulinate | HPNO | index |
| Butyl levulinate alone | 6250 | 0 | |
| 50:1 | 3125 | 63 | 0.56 |
| 25:1 | 3125 | 125 | 0.63 |
| 25:2 | 3125 | 250 | 0.75 |
| 25:4 | 1563 | 250 | 0.50 |
| 25:8 | 1563 | 500 | 0.75 |
| 25:16 | 781 | 500 | 0.63 |
| HPNO alone | 0 | 125 | |

### Sodium Pyrithione

| | MIC (ppm) to inhibit growth | | |
|---|---|---|---|
| Active weight ratio of Butyl | Butyl | Sodium | Synergy |
| levulinate:Sodium Pyrithione | levulinate | Pyrithione | index |
| Butyl levulinate alone | 6250 | 0 | |
| 800:1 | 3125 | 4 | 0.75 |
| 200:1 | 1563 | 8 | 0.75 |
| Sodium Pyrithione alone | 0 | 16 | |

Poly(hexamethylene) biguanide (PHMB)

| | MIC (ppm) to inhibit growth | | |
|---|---|---|---|
| Active weight ratio of Butyl | Butyl | | Synergy |
| levulinate:PHMB | levulinate | PHMB | index |
| Butyl levulinate alone | 6250 | 0 | |
| 10:1 | 1563 | 156 | 0.75 |
| 40:1 | 3125 | 78 | 0.75 |
| 80:1 | 3125 | 39 | 0.63 |
| 160:1 | 3125 | 20 | 0.56 |
| 320:1 | 3125 | 10 | 0.53 |
| 640:1 | 3125 | 5 | 0.52 |
| PHMB alone | 0 | 313 | |

What is claimed:

1. A preservative composition comprising
(i) at least one preservative agent; and
(ii) at least one levulinic acid derivative selected from (a) a levulinic acid ester, or (b) a levulinic ketal, and combinations thereof,
wherein the at least one levulinic acid derivative is present in an amount sufficient to increase the efficacy of the preservative agent as compared to the preservative agent alone.

2. The preservative composition according to claim 1, wherein the at least one levulinic acid derivative is present in an amount sufficient to increase the efficacy of the preservative agent at a pH of from 4 to 9, as compared to the preservative agent alone.

3. The preservative composition according to claim 1, wherein the preservative agent is selected from a group consisting of:
(i) an acid compound and salts thereof, an aldehyde, a phenolic compound, a sulfite, an iron chelator, an aromatic alcohol, a quaternary ammonium compound, a pyrone compound, a urea compound, a guanidine compound, a pyridine compound, an imidazole compound, an isothiazolinone compound, an amine compound, a carbamate compound, or any combination thereof;
(ii) phenoxyethanol, N,N-bis(3-aminopropyl) dodecylamine, didecyl dimethyl ammonium chloride, sodium benzoate, benzoic acid, lactic acid, sodium lactate, benzyl alcohol, benzisothiazolinone, sorbic acid, potassium sorbate, 3-Iodo-2-propynyl butylcarbamate (IPBC), dehydroacetic acid, sodium dehydroacetate, levuinic acid, sodium levulinate, sodium pyrithione, trisodium dicarboxymethyl alaninate, 2-butyl-1,2-benzisothiazolin-3-one, benzalkonium chloride, alkyldimethylbenzylammonium chloride (ADBAC), 2-hydroxypyridine-N-oxide, poly(hexamethylene) biguanide, and combinations thereof; or
(iii) sodium benzoate, benzoic acid, potassium sorbate, sorbic acid, 3-Iodo-2-propynyl butylcarbamate (IPBC), alkyldimethylbenzylammonium chloride (ADBAC), sodium pyrithione, lactic acid, sodium lactate, trisodium dicarboxymethyl alaninate, dehydroacetic acid, sodium dehydroacetate, benzisothiazolinone, 2-hydroxypyridine-N-oxide, poly(hexamethylene) biguanide, and combination thereof.

4. (canceled)

5. (canceled)

6. The preservative composition according to claim 1, wherein the levulinic acid ester is (i) a C₁₋₈ alkyl levulinic acid ester, a C₃₋₈ cycloalkyl levulinic acid ester, or a combination thereof; or (ii) ethyl levulinate, butyl levulinate, or a combination thereof.

7. The preservative composition according to claim 1, wherein the levulinic acid ester is selected from the group consisting of methyl levulinate, ethyl levulinate, propyl levulinate, butyl levulinate, pentyl levulinate, and combinations thereof.

8. (canceled)

9. The preservative composition according to claim 1, wherein the levulinic ketal is selected from the group consisting of ethyl-3-(2,4-dimethyl-1,3-dioxolan-2-yl)propanoate, ethyl-3-[4-(hydroxymethyl)-2-methyl-1,3-dioxolan-2-yl]propanoate, and combination thereof.

10. The preservative composition according to claim 1, wherein the preservative agent is:
(i) benzoic acid or a salt thereof, wherein the salt of benzoic acid is sodium benzoate, and wherein the at least one levulinic acid derivative and the benzoic acid or a salt thereof are comprised in the preservative composition at a weight ratio of from 50:1 to 1:50;
(ii) a sorbic acid or a salt thereof, wherein the salt of sorbic acid is potassium sorbate, and wherein the at least one levulinic acid derivative and the sorbic acid or a salt thereof are comprised in the preservative composition at a weight ratio of from 500:1 to 1:10;
(iii) 3-Iodo-2-propynyl butylcarbamate (IPBC) and wherein the at least one levulinic acid derivative and the 3-Iodo-2-propynyl butylcarbamate (IPBC) are comprised in the preservative composition at a weight ratio of from 25:1 to 1:2;
(iv) alkyldimethylbenzylammonium chloride (ADBAC) and wherein the at least one levulinic acid derivative and the alkyldimethylbenzylammonium chloride (ADBAC) are comprised in the preservative composition at a weight ratio of from 8000:1 to 500:1;
(v) sodium pyrithione and wherein the at least one levulinic acid derivative and the sodium pyrithione are comprised in the preservative composition at a weight ratio of from 8000:1 to 5:1;
(vi) lactic acid or a salt thereof, wherein the salt of lactic acid is sodium lactate, and wherein the at least one levulinic acid derivative and the lactic acid or a salt thereof are comprised in the preservative composition at a weight ratio of from 60:1 to 1:5;
(vii) trisodium dicarboxymethyl alaninate and wherein the at least one levulinic acid derivative and the trisodium dicarboxymethyl alaninate are comprised in the preservative composition at a weight ratio of from 5:1 to 1:5;
(viii) dehydroacetic acid or a salt thereof, wherein the salt of dehydroacetic acid is sodium dehydroacetate, and wherein the at least one levulinic acid derivative and the dehydroacetic acid or a salt thereof are comprised in the preservative composition at a weight ratio of from 300:1 to 1:10;
(ix) benzisothiazolinone and wherein the at least one levulinic acid derivative and the benzisothiazolinone are comprised in the preservative composition at a weight ratio of from 200:1 to 1:10;
(x) 2-hydroxypyridine-N-oxide and wherein the at least one levulinic acid derivative and the 2-hydroxypyridine-N-oxide are comprised in the preservative composition at a weight ratio of from 75:1 to 1:1; or
(xi) poly(hexamethylene) biguanide and wherein the at least one levulinic acid derivative and the poly(hexamethylene) biguanide are comprised in the preservative composition at a weight ratio of from 800:1 to 5:1.

11. (canceled)

12. (canceled)

13. (canceled)

14. (canceled)

15. (canceled)

16. (canceled)

17. (canceled)

18. (canceled)

19. (canceled)

20. (canceled)

21. An end-use formulation comprising the preservative composition according to claim 1.

22. The end-use formulation according to claim 21, wherein the end-use formulation has a pH of 4 or higher.

23. The end-use formulation according to claim 21, wherein the preservative agent comprised in the preservative composition is present in end-use formulation in an amount of from 1 wt.-% or less based on the weight of the end-use formulation.

24. The end-use formulation according to claim 21, wherein the preservative agent is selected from the group consisting of:
(i) an acid compound and salts thereof, an aldehyde, a phenolic compound, a sulfite, an iron chelator, an aromatic alcohol, a quaternary ammonium compound, a pyrone compound, a urea compound, a guanidine compound, a pyridine compound, an imidazole compound, an isothiazolinone compound, an amine compound, a carbamate compound, or any combination thereof, or
(ii) sodium benzoate, benzoic acid, potassium sorbate, sorbic acid, 3-Iodo-2-propynyl butylcarbamate (IPBC), alkyldimethylbenzylammonium chloride (ADBAC), sodium pyrithione, lactic acid, sodium lacerate, trisodium dicarboxymethyl alaninate, dehydroacetic acid, sodium dehydroacetate, benzisothiazolinone, 2-hydroxypyridine-N-oxide, poly(hexamethylene) biguanide, and combination thereof.

25. (canceled)

26. The end-use formulation according to claim 21, wherein the levulinic acid ester is (i) a C₁₋₈ alkyl levulinic acid ester, a C₃₋₈ cycloalkyl levulinic acid ester, or a combination thereof; or (ii) ethyl levulinate, butyl levulinate, or a combination thereof.

27. (canceled)

28. A method for increasing efficacy against microorganisms, comprising using the preservative composition according to claim 1, wherein the increase in efficacy is determined based on a comparison between the preservative composition and an equal amount of the preservative composition without the at least one levulinic acid derivative.

29. A method for increasing efficacy against microorganisms, comprising using at least one levulinic acid derivative selected from the group consisting of (a) a levulinic acid ester, or (b) a levulinic ketal, or a combination thereof in a preservative composition, wherein the increase in efficacy is determined based on a comparison between the preservative composition with the at least one levulinic acid derivative and an equal amount of the preservative composition without the at least one levulinic acid derivative.

30. The method according to claim 29, wherein the efficacy against microorganisms is increased at a pH of 4 to 9 or higher compared to an equal amount of the preservative agent at a pH of 4 to 9 without the at least one levulinic acid derivative.

31. The method according to claim 29, wherein the efficacy is increased by at least 0.5 log reduction.

32. The method according to claim 28, wherein the preservative agent is selected from the group consisting of:
(i) an acid compound and salts thereof, an aldehyde, a phenolic compound, a sulfite, an iron chelator, an aromatic alcohol, a quaternary ammonium compound, a pyrone compound, a urea compound, a guanidine compound, a pyridine compound, an imidazole compound, an isothiazolinone compound, an amine compound, a carbamate compound, or any combination thereof; or
(ii) sodium benzoate, benzoic acid, potassium sorbate, sorbic acid, 3-Iodo-2-propynyl butylcarbamate (IPBC), alkyldimethylbenzylammonium chloride (ADBAC), sodium pyrithione, lactic acid, sodium lactate trisodium dicarboxymethyl alaninate, dehydroacetic acid, sodium dehydroacetate, benzisothiazolinone, 2-hydroxypyridine-N-oxide, poly(hexamethylene) biguanide, and combination thereof.

33. (canceled)

34. The method according to claim 28, wherein the levulinic acid ester is (i) a C₁₋₈ alkyl levulinic acid ester, a C₃₋₈ cycloalkyl levulinic acid ester, or a combination thereof; or (ii) ethyl levulinate, butyl levulinate, or a combination thereof.

35. (canceled)

36. A method for preventing an end-use formulation from spoilage by microorganisms, the method comprising adding the preservative composition according to claim 1 to the end-use formulation.

37. The method according to claim 36, wherein the end-use formulation has a pH of 4 or higher.

38. The method according to claim 36, wherein the preservative agent is selected from the group consisting of:
(i) an acid compound and salts thereof, an aldehyde, a phenolic compound, a sulfite, an iron chelator, an aromatic alcohol, a quaternary ammonium compound, a pyrone compound, a urea compound, a guanidine compound, a pyridine compound, an imidazole compound, an isothiazolinone compound, an amine compound, a carbamate compound, or any combination thereof; or
(ii) sodium benzoate, benzoic acid, potassium sorbate, sorbic acid, 3-Iodo-2-propynyl butylcarbamate (IPBC), alkyldimethylbenzylammonium chloride (ADBAC), sodium pyrithione, lactic acid, sodium lactate, trisodium dicarboxymethyl alaninate, dehydroacetic acid, sodium dehydroacetate, benzisothiazolinone, 2-hydroxypyridine-N-oxide, poly(hexamethylene) biguanide, and combination thereof.

39. (canceled)

40. The method according to claim 36, wherein the levulinic acid ester is (i) a C₁₋₈ alkyl levulinic acid ester, a C₃₋₈ cycloalkyl levulinic acid ester, or a combination thereof; or (ii) ethyl levulinate, butyl levulinate, or a combination thereof.

41. (canceled)
